(19) United States
(12) Patent Application Publication
(10) Pub. No.: US 2021/0006933 A1
(43) Pub. Date: Jan. 7, 2021

(54) SECURITY MODEL USING INTEGRATED TECHNOLOGY

(71) Applicant: R. Thomas Dean, Shorewood, WI (US)

(72) Inventor: R. Thomas Dean, Shorewood, WI (US)

(21) Appl. No.: 16/919,932

(22) Filed: Jul. 2, 2020

Related U.S. Application Data
(60) Provisional application No. 62/870,564, filed on Jul. 3, 2019.
(60) Provisional application No. 62/876,349, filed on Jul. 19, 2019.

(51) Int. Cl. H04W 4/021; G06K 9/00; H04L 29/06; H04W 4/029; G16Y 40/10

(52) U.S. Cl. CPC H04W 4/021; G06K 9/00369; G16Y 40/10; H04L 63/0861; H04W 4/029; H04L 63/107

(57) ABSTRACT

Systems, methods and computer-readable storage media utilized for institution security based on a security model in a computer network environment. One method includes receiving, by one or more processing circuits, data from one or more IoT devices associated with an institution. The method further includes determining, by the one or more processing circuits, a total count of people within an area. The method further includes determining, by the one or more processing circuits, a location for each people within the area. The method further includes identifying, by the one or more processing circuits, each people within the area and generating, by the one or more processing circuits, a security report.

### CROSS-REFERENCE TO RELATED PATENT APPLICATIONS

This application claims priority to U.S. Provisional Application No. 62/870,564, filed Jul. 3, 2019, entitled “SYSTEMS AND METHODS OF SECURITY SERVICES,” and U.S. Provisional Application No. 62/876,349, filed Jul. 19, 2019, entitled “SYSTEMS AND METHODS OF POSITIVE ATTENDANCE,” all of which are hereby incorporated by reference in their entirety.

### BACKGROUND

The present invention relates generally to the field of security services. In a computer networked environment such as the internet, users and entities such as people or companies utilize security services to monitor, protect, communicate, and manage, events and/or institutions.

### SUMMARY

Some implementations relate to a system for providing security services with at least one computing device operably coupled to at least one memory cab be configured to receive data from one or more IoT devices associated with an institution. Further, the at least one computing device operably coupled to the at least one memory can be configured to determine a total count of people within an area. Further, the at least one computing device operably coupled to the at least one memory can be configured to determine a location for each people within the area. Further, the at least one computing device operably coupled to the at least one memory can be configured to identify each people within the area and generate a security report.

In some implementations, the at least one computing device operably coupled to the at least one memory can be further configured identify each people within the area based analyzing profiles from a database. In various implementations, the at least one computing device operably coupled to the at least one memory can be further configured to register, by a user device, a first user at the institution, send, by the user device, biometric information of the first user, receive, via a universal credential management system, a plurality of roles and an authorization code, provide, by the user device, the authorization code to the institution, and receive, via the universal credential management system, a confirmation that access was granted to the institution. In some implementations, the security report includes the total count of people, the location of each people, and an identification of each people within the area. In various implementations, the at least one computing device operably coupled to the at least one memory can be further configured to receive, by a user device, certification information associated with a second user, authorize the received certification information, and in response to authorizing the certification information, send the certification information to a plurality of institutions comprising at least the institution. In some implementations, the at least one computing device operably coupled to the at least one memory can be further configured to determine whether there is suspicious people within the area using the total count of people and identification of each people. In various implementations, the at least one computing device operably coupled to the at least one memory can be further configured to determine an event location of an event associated with the area. In some implementations, the at least one computing device operably coupled to the at least one memory can be further configured to receive first permission information and a first plurality of roles associated with the institution, receive second permission information and a second plurality of roles associated with a second institution, determine an assignment of a customized plurality of roles to a user, wherein the user is associated with the institution and the second institution and generate an authorization code for the user, wherein the authorization code provides access to the institution and the second institution. In various implementations, the at least one computing device operably coupled to the at least one memory can be further configured to receiving, via a user device, a user identity and determine a time for the user identity and storing the location, the time and the user identity.

Some implementations relate to a method of institution security based on a security model in a computer network environment, the method implemented by one or more processing circuits. The method include receiving data from one or more IoT devices associated with an institution. Further, the method includes determining a total count of people within an area. Further, the method includes determining a location for each people within the area. Further, the method includes identifying each people within the area and generating a security report.

In some implementations, the method further includes identifying each people within the area based analyzing profiles from a database. In various implementations, the method further includes registering a first user at the institution, sending biometric information of the first user, receiving, via a universal credential management system, a plurality of roles and an authorization code, providing, to a user device of the first user, the authorization code to the institution and receiving, via the universal credential management system, a confirmation that access was granted to the institution. In some implementations, the security report includes the total count of people, the location of each people, and an identification of each people within the area. In various implementations, the method further includes receiving, via a user device, certification information associated with a second user, authorizing the received certification information, and in response to authorizing the certification information, sending the certification information to a plurality of institutions comprising at least the institution. In some implementations, the method further includes determining whether there is suspicious people within the area using the total count of people and identification of each people. In various implementations, the method further includes determining an event location of an event associated with the area. In some implementations, the method further includes receiving first permission information and a first plurality of roles associated with the institution, receiving second permission information and a second plurality of roles associated with a second institution, determining an assignment of a customized plurality of roles to a user, wherein the user is associated with the institution and the second institution and generating an authorization code for the user, wherein the authorization code provides access to the institution and the second institution. In various implementations, the method further includes receiving, via a user device, a user identity and determining a time for the user identity and storing the location, the time and the user identity

Some implementations relate to one or more computer-readable storage media having instructions stored thereon that, when executed by at least one processing circuit, cause the at least one processing circuit to perform operations including receiving data from one or more IoT devices associated with an institution. Further the one or more computer-readable storage media having instructions stored thereon that, when executed by at least one processing circuit, cause the at least one processing circuit to perform operations including determining a total count of people within an area. Further the one or more computer-readable storage media having instructions stored thereon that, when executed by at least one processing circuit, cause the at least one processing circuit to perform operations including determining a location for each people within the area. Further the one or more computer-readable storage media having instructions stored thereon that, when executed by at least one processing circuit, cause the at least one processing circuit to perform operations including identifying each people within the area and generating a security report.

In some implementations, the one or more computer-readable storage media having instructions stored thereon that, when executed by at least one processing circuit, cause the at least one processing circuit to perform operations further including registering a first user at the institution, sending biometric information of the first user, receiving, via a universal credential management system, a plurality of roles and an authorization code, providing, to a user device of the first user, the authorization code to the institution and receiving, via the universal credential management system, a confirmation that access was granted to the institution.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a general block diagram of a system for providing security services within an area according to some illustrative embodiments.

FIG. 2 is a schematic drawing illustrating a security system providing real time location and identification of people within a room according to some example embodiments.

FIG. 3 is a schematic drawing illustrating a security system providing real time location and identification of people within a building according to some example embodiments.

FIG. 4 is a schematic drawing illustrating operations of a security system in a tip-line scenario according to some example embodiments.

FIG. 5 is a flow diagram illustrating a process of providing security services within an area according to some example embodiments.

FIG. 6 is a flow diagram illustrating a process of communicating individual specific information according to some example embodiments.

FIG. 7 is an illustration of a user interface of a mobile device application menu screen for interacting with a security system according to some example embodiments.

FIG. 8 is an illustration of a user interface of a mobile device application display requesting the user to provide the security system with information in response to a medical emergency according to some example embodiments.

FIG. 9 is an illustration of a user interface of a mobile device application requesting the user to upload an image of a person having a medical emergency to the security system according to some example embodiments.

FIG. 10 is an illustration of a user interface of a mobile device application requesting the user to select their location during a medical emergency so that the location may be uploaded to the security system according to some example embodiments.

FIG. 11 is an illustration of a user interface of a mobile device application requesting the user for information regarding whether the medical emergency is life threatening so that the information may be uploaded to the security system according to some example embodiments.

FIG. 12 is an illustration of a user interface of a mobile device application requesting the user to provide the security system with the type of medical emergency according to some example embodiments.

FIG. 13 is an illustration of a user interface of a mobile device application that allows the user to see protocols for the medical emergency sent from the security system, receive training regarding CPR, and add more information in to the system according to some example embodiments.

FIG. 14 is an illustration of a user interface of a mobile device application that allows the user to read the protocol for the medical emergency sent from the security system according to some example embodiments.

FIG. 15 is an illustration of a user interface of a mobile device application that allows the user to upload more information to the security system according to some example embodiments.

FIG. 16 is an illustration of the web dashboard home screen that allows people to see the information uploaded to the security system according to some example embodiments.

FIG. 17 is an illustration of a web dashboard displaying the medical emergency information uploaded to the security system according to some example embodiments.

FIG. 18 is an illustration of a web dashboard displaying the incident report for a particular medical emergency from the security system according to some example embodiments.

FIG. 19 is a schematic drawing illustrating an integrated attendance system recording the presence of a student in a classroom according to some example embodiments.

FIG. 20 is a schematic drawing illustrating an integrated attendance system recording the presence of a person on a bus according to some example embodiments.

FIG. 21 is a schematic drawing illustrating operations of an integrated attendance system operating off-site at an evacuation point according to some example embodiments.

FIG. 22 is a block diagram depicting an implementation of a universal credential management system, according to an illustrative implementation.

FIG. 23 is a schematic drawing of an example implementation of a universal credential management system within a multi-tenancy structure, according to an illustrative implementation.

FIG. 24 is a schematic drawing of an example configuration of the universal credential management system within a multi-tenancy structure, according to an illustrative implementation.

FIG. 25 is a flow diagram illustrating a process of providing management of user credentials within a multi-tenancy structure, according to an illustrative implementation.

FIG. 26 is a flow diagram illustrating a process of a user gaining access to one or more institutions within a multi-tenancy structure, according to an illustrative implementation

FIG. 27 is a flow diagram illustrating a process of a updating the authorization code based on information provided by the user within a multi-tenancy structure, according to an illustrative implementation.

FIG. 28 is a block diagram of a computing system, according to an illustrative implementation.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the figures, systems and methods for providing security services are described according to various embodiments in the present disclosure. The security services include, but are not limited to, real time location, identification, response protocols, integrated attendance, find/locate responsible parties, communication, universal credential management in a multi-tenancy structure (universal multi-tenancy credential management or “UCM”), and audit trail according to some embodiments. The security services are provided using one or more internet of things devices (collectively referred to herein as “IoT devices), human crowdsourced information from mobile devices, data from one or more external data sources, according to some embodiments. In some embodiments, an evolving ecosystem of data from external data sources, IoT devices, human and artificial intelligence workflows and algorithms to improve security services is provided. The ecosystem includes databases, IoT Devices, hardware, computer storage and processing power, integrated networks, mobile devices, and interfaces with people in some embodiments.

The real time location services can locate people and events within an area that the systems applied (e.g., in a building, in a park, virtual, etc.) utilizing various identification techniques (e.g., facial recognition, QR codes, ID numbers, IoT devices, external data sources, mobile devices, etc.), according to some embodiments. In various embodiments, event contingent workflows can also be provided indicating instructions and information for an individual based on a status (e.g., normal, active shooter, evacuation, medical emergency, etc.) of an event (e.g., emergency). In various implementations, a status can evolve based on a situation (e.g., normal now to active shooter). The identification services can identify individual persons in the area, according to some embodiments. The identification services can be used to identify people before those people are granted access to a building, in some embodiments. The response protocols services can provide detailed and emergency specific protocols (e.g., workflows), according to some embodiments. The response protocols can provide dynamic, or evolving instructions, according to some embodiments. The communication services can also provide various instantaneous communications among different constituents depending on the situation, such as immediate communications between area/building occupants, schools, hospitals and police & fire departments. The communication services also enable multiple parties to receive the same information simultaneously, according to some embodiments. The communication services can provide individual specific information (e.g., individual health or education plan, Students with Disabilities Section 504 plan, employee disciplinary reports, etc.) to authorized recipients, in some embodiments. In some embodiments, the audit trail services provide storage and retrieval of all data and meta-data in the area of drills and incidents, in some embodiments. The audit trail services allow for various detailed reporting purposes such as Federal, State, regulatory, insurance, litigation purposes, etc.

The integrated attendance services can be utilized to track individuals such that the attendance of individuals (e.g., people on a school bus, in a lecture hall, at a conference, in an office, on a plane, and/or on a train) can indicate what location the individual is in and at what time. In one example, in a school setting, attendance is the process of recording a student's attendance based on time such that the students are marked present, and their presence and location is time stamped. In this example, if the time stamp is later than the scheduled beginning of the class period, then the student is considered tardy and if the student does not register as present, then the student is marked absent. In some embodiments, the attendance services can begin with a blank attendance list such that as attendee's check-in they can be added/registered to the attendance list. In some embodiments, a integrated attendance services can include, but are not limited to, allowing individuals (e.g., students, attendees) to provide integrated attendance (e.g., check themselves in) for an event (e.g., class, boarding a school bus to school, conference, sporting event, etc.) by providing individualized biometric data (e.g., thumbprint, facial recognition, retinal scan, etc.). For example, students can provide integrated attendance for boarding a school bus. Further in the example, teachers and school leaders could enable integrated attendance in remote locations away from school property (e.g., at an evacuation point, on a field trip, at a sporting event, etc.). More in the example, a teacher or school leader can use a mobile device to take a student's attendance in a hallway, locker room, lavatory, office or other location, denoting the time and location of the student's presence (or attendance).

The universal credential management services can include institutions (i.e. commercial buildings, schools, hospitals, airports, etc.), referred to as tenants, that assign credentials to roles that are unique to that institution. These credentials can be permissions that define a role's physical, data, or application access inside an institution. Typical roles that can be found in businesses, schools and hospitals, among other institutions, would be employee, contractor, tenant, teacher, student, parent, doctor, nurse and/or patient. In addition to these roles, there is a potentially infinite number of specific roles and associated permissions that an institution may want to use to define permissions. In some implementations, every individual that is associated with a unique institution is categorized into an associated role as defined by that institution. For example, there are many school districts (e.g. individual and independent school institutions) in the U.S., and each assign the role of teacher. Each individual school district defines the unique permissions it allows its teacher roles, and each school institution may have hundreds of individual people assigned to the role of teacher, enabling the combinations of access unlimited.

Referring to the universal credential management services generally, in many systems, individuals are assigned roles and provided credentials that define their relationship within every singular institution they are affiliated with, and each is maintained singularly by each institution, where every individual person is defined as a user. For example, a user who is a parent at a school and an employee in an office has different roles in two different institutions. In many systems, that user will receive individual user credentials unique to each institution, for example: employee badges, physical door keys, biometric ID, driver's licenses, or mobile applications dedicated to the institution. These different credentials will be administered independently by the two different institutions, in a single tenant structure. Single tenancy requires that user credentials are unique to an institution (e.g. one company, one school, one hospital, etc.), and are not portable with a person, and do not contain permissions associated with unrelated physical locations or institutions. However, the ability to control user credentials across institutions such that each individual can retain credentials at multiple unaffiliated institutions, provides institutions and individuals enhanced flexibility for managing user credentials. This causal approach provides significant improvements on how user credentials can be administered and provides individuals that utilize credentials across multiple unrelated institutions a central location that stores, manages, and administers credentials, certificates, and other user information. Therefore, aspects of the present disclosure address problems in user credential systems by providing an improved user credential tool for the storing, managing, and administering user credentials across multiple unrelated institutions.

Accordingly, aspects of the present disclosure are directed to systems and methods for universal multi-tenancy credential management (UCM) (e.g., a type of security service). That is, UCM can be used by institutions to assign roles and credentials to individuals and to allow individuals to retain and use their credentials at multiple unaffiliated institutions. In some implementations, users can receive their unique credentials related to any tenant from smartphones, mobile devices, laptop computers, biometrically, QR code badges, driver's license, temporary visitor badges, remote keyless entry fobs (RKEs), worm electronic devices (strap, ring, helmet, etc.). In various implementations, each institution, or each institution's facility (configurable by the institution itself) can be one tenant in the multi-tenant structure. Each tenant's administrator can configure its unique roles, assign individuals, define rules and permissions for its individual tenant. Each tenant can set rules that apply to security settings, institutional policies, and other requirements. Security settings are fully configurable by the tenant administrator and could include requiring smart phone users to enable biometric authentication on their phone (e.g. facial recognition, fingerprint, etc., randomly generated authorization codes to be used at keypads, scans of driver's licenses to match records, etc.). In some implementations, each tenant can also set its tenant policies that will then supersede any individual user consents. For example, if a tenant's policy is to require everyone to submit to facial recognition, then an individual user cannot opt-out of being submitted to facial recognition. In various implementations, tenants can also adopt a user opt-in policy, such that it could allow individual users to configure their own consent to be submitted to facial recognition, share health data, etc. Tenants can also adopt a default opt-in, but allow users to choose to opt-out. In some implementations, user credentials can be stored on an application program (App) that can execute on a device of the user.

As used herein, a “user” may be any individual communicating with any of the systems described herein.

As used herein, a “tenant” may refer to an institution. An example of a tenant could include, but is not limited to, a school, a hospital, an airport, a company/business. In the example of a business it could be the entire business, or further subdivided by location. For example, at Company 1, Company 1 may be a resident at a building in Wisconsin, and a building in Texas. Each location may have the same credentials but include specific access for certain employees based on which location the certain employee works at.

As used herein, “roles” are categories defined by each tenant for each user and/or group of users. For example, a role could be categorized as teachers, students, employees, consultants, visitors, doctors, etc. Thus, depending on the tenant's needs, roles can be segmented by individual users into specific categories.

As used herein, “permissions” are the permissions and rules that are set by the tenant. For example, building access (e.g., door lock/unlocking, access to restricted areas), access to data maintained by an application, and ability to access other systems as defined by the tenant.

As used herein, “tenant policies” are the policies set by the tenant. For example, requiring all people to submit to facial recognition, requiring all health data to be shared with all appropriately credentialed staff members, security requirements (e.g., requiring users to use facial recognition or fingerprint access to their mobile phone).

As used herein, “user credentials” are the credentials assigned by every tenant.

As used herein, “user consents” absent a tenant policy to the contrary, these are the consents that a user can establish, for each tenant they are affiliated with. The system can allow a user to have credentials at an infinite number of tenants, and can see/configure their consents for every individual tenant. For example, consents could be submitting to facial recognition, sharing of health data, etc. In an example of minor children, in a school tenant, guardians will also be able to configure the consents for their minors, whereas minors could not change their own consents until they are a certain age.

As used herein, “user certifications” are anything that a user adds to their profile that is then shared with all affiliated tenants. For example, if a user wanted to get a 3^{rd} party background check on themselves that can then be shared with all existing and new tenants that are affiliated with the user. Another example would be CPR certifications, if a user wanted to let all affiliated tenants know that they are CPR certified they could provide this information in their user credential management system that would then share it with any affiliated tenant, such that if they were at a tenant location and there was a need for a CPR trained person, the user could be notified.

As used herein, “access” is using user credentials at a tenant site to gain access to facilities. In one example, access could be completely controlled by location, down to the door level, and time. Access could be achieved using biometrics/facial recognition with cameras, QR Code readers, proximity readers and BLE (i.e. a user's phone is close to the door so it unlocks/opens), code panels, or any other know access procedures.

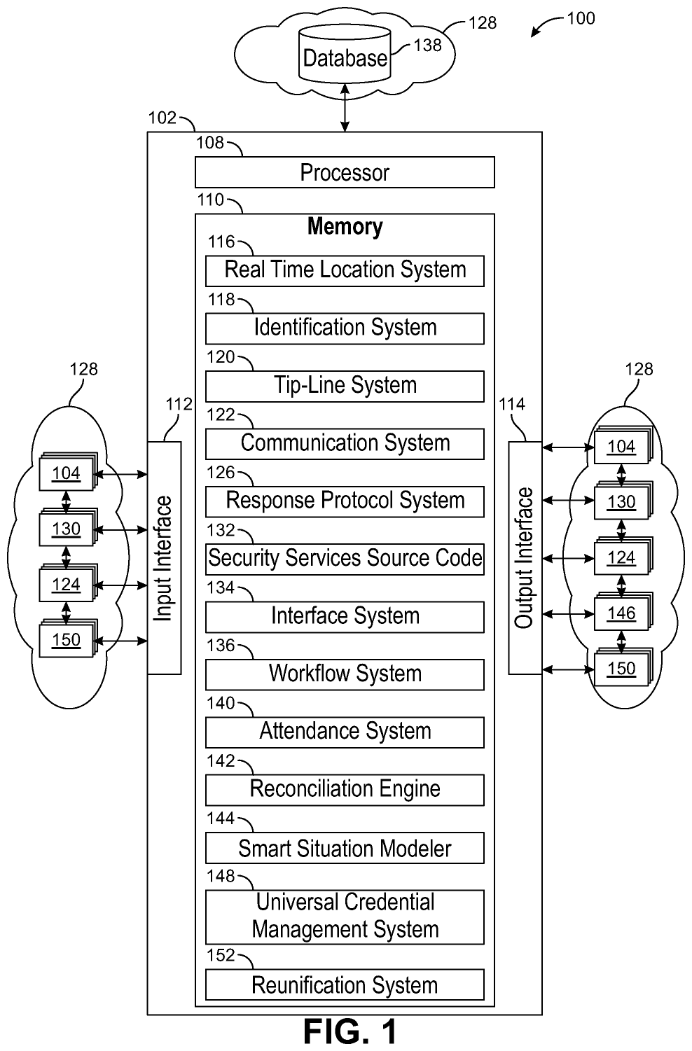

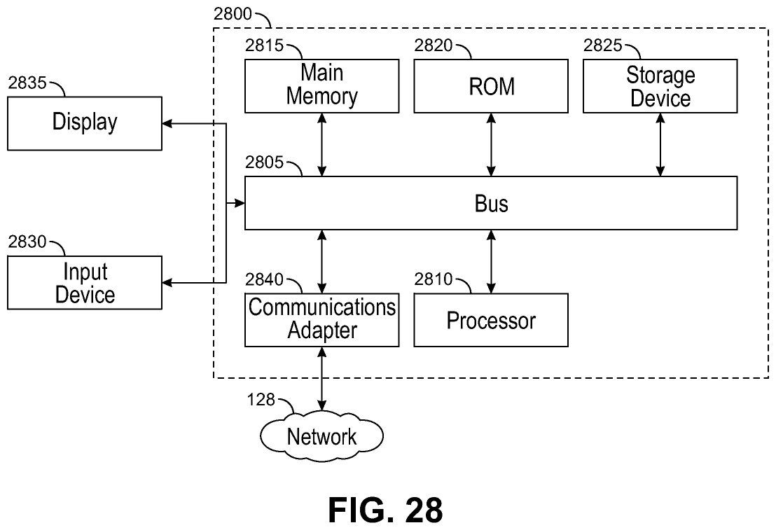

Referring now to FIG. 1, a diagram of a security system 100 for providing security services within an area (e.g., a school, a building, a park, a sporting event, a music event, an enclosed area, a virtual area, any area, etc.) is shown according to some illustrative embodiments. The security system 100 includes a central processing system 102, a plurality of IoT devices 104, an alert system 106, one or more user devices 124, and external data sources 130, according to some embodiments. The central processing system 102 includes an input interface 112, an output interface 114, a processor 108, and a memory 110, according to some embodiments. The memory 110 includes a real time location system 116, an identification system 118, a tip-line system 120, a response protocols system 126 and a communication system 122, according to some embodiments. The systems 116, 118, 120, 122, 126, 130, 132, 134, 136, 140, 142, 144, 146, and 148 can be implemented in circuitry, software, one or more local or remote servers, edge, proxy computers, fog computers and/or cloud computers (e.g., proxy servers, external data sources, etc.), or combinations thereof. The central processing system 102, IoT devices 104, alert system 106, external data sources 130, emergency systems 146, and user devices 124 are connected and can communicate via a network 128, which can include one or more public or private networks, according to some embodiments. In some implementations, system 100 can be executed on one or more processing circuits, such as those described in detail with reference to FIG. 28.

In general, one or more processing circuits can include a microprocessor, an application specific integrated circuit (ASIC), a field-programmable gate array (FPGA), and so on, or combinations thereof. A memory can include, but is not limited to, electronic, optical, magnetic, or any other storage or transmission device capable of providing processor with program instructions. Instructions can include code from any suitable computer programming language. t should be understood that various implementations may include more, fewer, or different systems than illustrated in FIG. 1, and all such modifications are contemplated within the scope of the present disclosure.

The network 128 may include a local area network (LAN), wide area network (WAN), a telephone network, such as the Public Switched Telephone Network (PSTN), a wireless link, an intranet, the Internet, or combinations thereof. The security system 100 can also include at least one data processing system or processing circuit, such as processor 108, user devices 124, IoT devices 104, and/or alert system 106. The processor 108 can communicate via the network 128, for example with user devices 124, IoT devices 104, and/or alert system 106.

In some implementations, the central processing system 102 can be configured to query the database 138 for information and store information in the database 138. For example, the user devices 124 and/or IoT devices 104 can retrieve data stored in the database 138 that can be utilized to execute an applications associated with security services. In another example, the central processing system 102 can send and/or retrieve data stored in the database 138 to perform various functions (e.g., identification, verification, workflow data, etc.) associated with security services. The data stored in the database 138 may include personal information (e.g., names, addresses, phone numbers, and so on), authentication information (e.g., username/password combinations, device authentication tokens, security question answers, unique client identifiers, biometric data, geographic data, social media data, and so on), financial information (e.g., token information, account numbers, account balances, available credit, credit history, exchange histories, and so on) relating to the various users and associated financial accounts, workflow data, identification data, tip-line data, and so on. In some arrangements, the database 138 may include a subset of databases such that the central processing system 102 can analyze each database to determine the appropriate information for events, credentials, anything related to institutions, and related computing tasks.

The IoT devices 104 can be disposed in various locations within the area according to some embodiments. The IoT devices 104 are configured within a network (e.g., wired and/or wireless network), according to some embodiments. The IoT devices 104 communicate with the central processing system 102 through the network, according to some embodiments. The IoT devices 104 provide information to the external data sources 130 (e.g., proxy) and/or directly to the central processing system 102 for calculating area occupancy (e.g., building) and room occupancy, identifying and locating all people in a building to a room level precision, locating events (e.g., explosions, gunfire, seismic events, fire, deteriorating air quality, etc.), and identifying and locating specific threats (e.g., weapons, people who appear to be carrying dangerous objects, people who are not permitted in the area, people who appear to be wearing specific attire, etc.) via the network 128, according to some embodiments. In various implementations, the IoT devices 104 can be new or potentially legacy IoT Devices that are already in the building such the existing infrastructure can be utilized.

The IoT devices 104 can include, but are not limited to any or all user mobile devices (phones, GPS devices), network enables devices, any suitable gunshot detection systems, gunfire locator, acoustic sensor, infrared (IR) counter sensors, cameras (e.g., of any wavelength and including low resolution cameras, high resolution cameras, infrared, etc.), radio-frequency identification (RFID) sensors, Bluetooth low energy (BLE) beacon sensors, fire sensors, IP microphones, decibel meter, carbon monoxide (CO) sensors, Geiger counter sensors, seismometers, barometers, relays, door sensors, window sensors, any suitable commercial or residential security sensors, any suitable weather sensors, any suitable natural disaster sensors, Wi-Fi triangulation sensors, ultra-wideband arrays (UWB), geolocation sensors, RFID sensors, a desktop computer, a laptop or notepad computer, a mobile device such as a tablet or electronic pad, a personal digital assistant, a smart phone, a video gaming device, a television or television auxiliary box (also known as a set-top box), a kiosk, a hosted virtual desktop, or any other such device capable of exchanging information via the network 128. The beacon sensors may provide a more precise location than Wi-Fi triangulation sensors, according to some embodiments. In various implementations, the beacon sensors can utilize Bluetooth to collect location data from mobile devices of the occupants or from a beacon carried by the occupant (e.g., a work ID, card key, etc.). In some implementations, the ultra-wideband array can collect UWB beacon data carried by the occupant. The security system 100 can use a combination of different types of IoT devices connected within a network (or outside a network) (e.g., network 128) to track assets, according to some embodiments. In this way, the security system 100 can provide security services with higher precision, higher location accuracies, customized event-specific responses, lower latency, and lower bandwidth consumption, according to some embodiments.

In various implementations, the IoT devices 104 can be utilized to perform various tasks. For example, the cameras can be used for facial or cranial recognition, according to some embodiments. In various implementations, cameras can be used for general object identification (e.g. finding a person, finding a vehicle, etc.). In another example, the cameras can also be used to calculate the number of people in a room, according to some embodiments. In yet another example, the cameras can be used to analyze people's gait or emotional state, according to some embodiments. In yet another example, the cameras can be used to identify dangerous objects (e.g., weapons, dangerous chemicals, etc.). In some implementations, the cameras and IR sensors can be used to count the number of people in a room by time of flight or body heat, neither of which may require anything other than the people (or individuals) in the room, according to some embodiments. The IR sensors can detect people in any light environment (e.g., bright light, dark light, etc.), according to some embodiments. The IR sensors can be used to count people anonymously, or designate people by role (e.g., staff, visitors, vendors, student, manager, construction worker, manufacturer worker, etc.). The Wi-Fi triangulation sensor can be used to locate mobile devices that are connected to a Wi-Fi network, according to some embodiments. The BLE beacon sensors can be used to provide a precise location of people may who carry a mobile device, or may carry a beacon (e.g., a work ID, card key, etc.), according to some embodiments. The UWB arrays can be used to provide a precise location of people who may carry a UWB beacon, according to some embodiments. Additionally, users can self-report location using the interactive push-button map in an application on their mobile device. The security system 100 may determine a total number of people within an area using multiple IoT Devices at the same time, according to some embodiments. The security system 100 may calculate an accurate total number by aggregating the calculated total numbers associated with each IoT device using algorithms employing statistical interference filters, according to some embodiments. For example, in calculating the aggregated accurate total number, the total number associated with the IR sensor may have the highest weight variable in the statistical inference filter, according to some embodiments.

The external data sources 130 can provide data to the central processing system 102 based on the central processing system 102 requesting and/or receiving data from external databases associated with an institution (e.g., company, construction site, manufacturing floor, school, medical facility). The external data sources 130 can collect data from other devices on network 128 (e.g., IoT Devices 104, user devices 124) and relay the collected data to the central processing system 102. In one example, a school may have a server and database (e.g., prem proxy, SIS proxy, enterprise resource planning (ERP) system, etc.) that stores information associated with students, teachers, administrators. In this example, the central processing system 102 may request data associated with specific data stored in the data source (e.g., external data sources 130) of the school. In another example, camera data may be stored locally at an institution in a data source (e.g., external data sources 130) and send/requested and sent to the central processing system 102.

The external data sources 130 can also provide data to the central processing system 102 based on the central processing system 102 scanning the internet (e.g., various data sources and/or data feeds) for data associated with a specific area. In various implementations, scanning can utilize an internet wide scanning tool (e.g., port scanning, network scanning, vulnerability scanning, ICMP scanning, TCP scanning, UDP scanning, etc.) for collecting data. The data collected may be newsfeed data (e.g., articles, breaking news, television, etc.), social media data (e.g., Facebook, Twitter, Snapchat, TikTok, etc.), geolocation data of users on the internet (e.g., GPS, triangulation, IP addresses, etc.), governmental databases (e.g., FBI databases, CIA databases, Coronavirus database, No Fly List databases, terrorist databases, sex offender registry, etc.), and any other data associated with a specific area of interest. In some implementations, scanning occurs in real-time such that the external data sources 130 continuously scans the internet for data associated with the specific area. In various implementations, scanning may occur in periodic increments such that the external data sources 130 scans the internet for data associated with the specific area periodically (e.g., every minute, every hour, every day, every week, and any other increment of time, etc.) External data sources 130 may receive feeds from be various data aggregating systems and/or entities that collect data associated with specific areas. For example, the central processing system 102 can receive specific area data from the external data sources 130, via the network 128.

The input interface 112 receives data from the IoT devices 104 and one or more user devices 124, according to some embodiments. The workflow system 136 can provide customized workflows to users based on roles and current event status, according to some embodiments. In various implementations, a status can evolve based on a situation (e.g., normal now to active shooter) such that different workflows and tasks are performed based on the status. The user devices 124 can be used to identify people or objects, locate people or objects, collect information associated with the area, and collect other human crowdsourced data (e.g., workflow question and answers), according to some embodiments. In some embodiments, the camera in a user device can be used to photograph a person (e.g., a person in a medical emergency, suspicious person, etc.) or object (e.g., a suspicious car, motorcycles, bicycles, heavy equipment, etc.), this photo can be used with the identification system 118 to identify the person or object, this photo can be used by the security services source code 132 to quantify the number of times and locations the person or object has been on the premises (or area), and the communication system 122 to communicate specific person related information. The user devices 124 includes, but is not limited to a desktop computer, a laptop or notepad computer, a mobile device such as a tablet or electronic pad, a personal digital assistant, a smart watch, a smart phone, a video gaming device, a television or television auxiliary box (also known as a set-top box), a kiosk, a hosted virtual desktop, any other smart electronic device (e.g., helmet, band, strap, ring, jewelry, imbedded clothing device, headphones, geolocator, GPS), beacons, work IDs, security fob, or any other such device capable of exchanging information via the network 128

The processor 108 can include one or more processors (e.g., any general purpose or special purpose processor), hosted on premises (e.g., proxy, edge or fog computing) and/or remotely (e.g., the cloud), according to some embodiments. The processor 108 is operably coupled to the memory 110, according to some embodiments. The memory 110 includes one or more transitory and/or non-transitory storage mediums and/or memories (e.g., any computer-readable storage media, such as a magnetic storage, optical storage, flash storage, RAM, ROM, etc.), according to some embodiments. In some embodiments, the processor 108 may include the memory 110. The processor 108 is configured to perform various functions stored in the memory 110. The memory 110 is configured to store various functions for providing security services, according to some embodiments. The memory 110 can include any type of storage (e.g., solid state, disk drive, server, etc.), according to some embodiments.

The real time location system 116 can be configured to determine locations for specific events, people, and objects using the data received from the IoT devices 104, user devices 124, and external data sources 130, according to some embodiments. Referring to the real time location system 116 generally, locating individuals in any emergency is important. For example, during a shooting in an area, for many parties (e.g., police, management, loved ones, etc.), it can be essential to know where and what individuals are currently either in the area or outside the area. In various implementations, the real time location system 116 is configured to locate all the people in an area (e.g., building, grounds, stadium, virtual area (e.g., geo-fence), etc.) using statistical inference generated by the security services source code 132 with data from the IoT devices 104, data from user devices 124, data from workflow system 136, data from external data sources 130, demographic data, and data from any other system described herein, according to some embodiments. In some embodiments, the demographic data indicates the people expected to be in a specific room at any given time. For example, in a school environment, the security system 100 may receive demographic data by downloading student enrollment data (e.g., from external data sources 130, database 138). In another example, in an office or other environment, the security system 100 may receive demographic data by downloading a corporate office/seating chart (e.g., from external data sources 130, database 138). In yet another example, in a hospital environment, the security system 100 may receive demographic data by downloading a hospital schedule. In yet another example, in a construction environment, the security system 100 may receive demographic data by downloading construction crew data (e.g., from external data sources 130, database 138). In yet another example, in an event, the security system 100 may receive demographic data by downloading the ticket list. In various implementations, the real time location system 116 is configured to use the IoT devices 104 and the network 128 to locate any incident (e.g., an active shooter incident, injured people, dangerous object, medical emergency, suspicious person, etc.).

The identification system 118 can be configured to identify specific events and identify individuals, according to some embodiments. The identification system 118 is configured to identify a type of event or events (e.g., gunfire, dangerous object, suspicious person or vehicle, volatile organic compounds, deteriorating air quality, fire, seismic events, etc.) using the data received from the IoT devices 104, user devices 124, and/or external data sources 130 (e.g., news feeds, internet feeds, social media feeds, federal government feeds, etc.). The identification system 118 can be configured to identify individuals using both the IoT devices 104 data, data from external data sources 130, and crowdsource human data received from the user devices 124, according to some embodiments. For example, the identification system 118 may identify and store building occupancy using the data from the IoT devices 104. In this example, the identification system 118 may further detect specific people with BLE or UWB beacons and/or from each user device. In some embodiments, the identification system 118 includes an expected roll database storing an expected roll for a specific area (e.g., a classroom, an office, a hospital, a construction site, a manufacturing floor, a sporting event, a music concert, etc.). The identification system 118 may update the roll data in real-time based on the data received from the IoT devices 104, workflow system 136, external data sources 130, the user devices 124, and any other system described herein, according to some embodiments. For example, in a classroom, a teacher can be presented a list of students that are not detected by the IoT devices, and then take roll by clicking names to confirm missing students on a user device according to some embodiments. When used in this manner, the identification system 118 may reconcile the number of people in the room to confirmed identities. Anytime a teacher uses this function, the identification system 118 can update its expected roll database, according to some embodiments. The identification system 118 may identify a person or persons (e.g., during a medical emergency, a suspicious person, people in a fight, etc.) from a photo taken from a user's device 124, IoT devices 104, or posted on social media via the external data sources 130. The crowdsource human data may include self-reported data, according to some embodiments. For example, in school, the security system 100 allows the students to self-report location and identification of themselves, injured people, events, etc., according to some embodiments. The identification system 118 can use a combination of the IoT device data, external data, expected roll database, workflow data, and the self-reported data to determine a true list of missing or unaccounted for students or any person, according to some embodiments.

The smart situation modeler 144 can be configured to generate predictions and/or actions based on analyzing a plurality of input data. In various implementations, the smart situation modeler 144 may be trained utilizing previous collected data by central processing system (e.g., stored in database 138). The smart situation modeler 144, can utilize the one or more processing circuits of the processor 108 to generate output predictions (e.g., threat matrix, potential threat score, severity of situation estimator) based on received data. In some implementations, the output prediction can predict how likely a person is actually who they are. For example, the smart situation modeler 144 may receive images taken by user devices 124, and subsequently generate a prediction that the image (i.e., facial recognition) is a specific person (e.g., 50% likely that the image is that specific person). Accordingly, facial recognition and event recognition can be utilized to generate prediction for utilization by various systems described herein. In various implementations, the output prediction can predict a potential threat based on received information (e.g., from IoT devices, user devices 124, external data sources 130, and/or any other systems described herein). For example, a sensor collected an air sample indicating gun powder was in the air. In this example, the output prediction can predict the potential threat associated with gun powder in the air, where the higher the score the higher the potential threat. Further in this example, the potential threat score may be 98/100 indicating the gun powder could be associated with gun fire which could subsequently send notifications to other systems described herein (e.g., new workflow created, new status, etc.). Further in this example, the potential threat score may be 15/100 indicating the gun powder could be from a science experiment in a lab (e.g., indicating a different workflow creation, and different status, etc.). As shown, the smart situation modeler 144 can utilize metadata collected and stored herein to produce various output predictions and subsequent notify various systems described herein. In some implementations, the output prediction can be a threat matrix or severity of situation estimator. The threat matrix may be a matrix indicating threats to various parts of an area, and/or various individuals in the areas. For example, if peanuts were discovered in a classroom that was peanut free, a threat matrix may indicate each student allergic to peanuts in the room as well as each student allergic to peanuts in the school. In the following example, the students in the room that are allergic to peanuts may have a higher risk whereas students just in the school that are allergic to peanuts may be at less risk. The severity of situation estimate may be an estimation indicating the severity of a particular incident. For example, a school shooting may have a high severity estimation (e.g., 92/100) whereas individual in a fight may have a lower severity estimation (e.g., 42/100). Accordingly, various output predictions described herein are output prediction based on specific specialized incidents or events, such that it can be universally utilized across various institutions and utilize resources across various institutions. In another example, if someone is determined to have tested positive for a disease/virus (e.g., coronavirus), a threat matrix may indicate each student and person in a school the likelihood (e.g., 100%) they were in contact with the individual or that they were in contact with a different individual that was in contact with the individual (e.g., 3%, 56%, etc.).

In various implementations, output predictions may include using a machine learning algorithm (e.g., a neural network, convolutional neural network, recurrent neural network, linear regression model, sparse vector machine, and so on). The one or more processing circuits can input one or more pieces of data and/or events into the machine learning model and receive an output from the model providing various scores and predictions.

The tip-line system 120 can be configured to provide advanced warning and identification potentially dangerous people in a community (e.g., school, workplace, house of worship, construction site, sporting event, music concert, etc.) in order to protect people within the area, according to some embodiments. The tip-line system 120 may be configured to receive tip data that indicates suspicious activity and/or suspicious people from the IoT devices 104, external data sources 130, and/or the user devices 124, according to some embodiments. In various implementations, once the tip-line system 120 receives tip data indicating one or more suspicious people, the tip-line system 120 may automatically generate a detailed report of each of the one or more suspicious people, according to some embodiments. The tip-line system 120 can generate the detailed report by accessing an occupant information system database (e.g., student database, employee database, sex offender registry, federal government database, etc.) that includes files for each occupant within the area, according to some embodiments. In some implementations, the tip-line system 120 may generate report indicating life-changing events of the suspicious people (e.g., academic performance, truancy, parents' divorce, court records, health records, death of a loved one, or disciplinary actions, etc.), according to some embodiments. The report data may be used to create a potential threat score, or threat matrix, estimating the severity of the situation, according to some embodiments. In some embodiments, threat scores or threat matrices may be used to create a prioritized list of suspicious people. These lists may be used in conjunction with the identification system 118 to limit area access or provide advanced warning to security administrators (e.g., administrator of the area and/or area management), according to some embodiments.

The communication system 122 can be configured to communicate in real time with all or specified area occupants. In addition to typical area occupant communications, the communication system 122 can communicate the determined locations of people and events from the real time location system 116 and the identified information of events and people from the identification system 118 and the appropriate emergency response from the response protocols 126 with the alert system 106, external data sources 130, and/or the user devices 124 through the output interface 114, according to some embodiments. The alert system 106 can be connected to security administrators (e.g., building administration, principals, superintendents, teachers, police, security personals, etc.), according to some embodiments. In some embodiments, the communication system 122 can be configured to generate alerts and/or report messages to the user devices 124 in order to provide updates and/or warnings during an event. The communication system 122 can be configured to communicate person specific information to authorized users when required (e.g., a person's specific medical plan, a detailed report on a person's behavior, alert of a person in the building who is on a Do Not Allow list, etc.) The communication system 122 can also be configured to communicate with any other suitable system and/or personals (e.g., communicate to fire station, police department, health officials, FEMA, federal government, etc.). The output interface 114 enables communications via any suitable wired and wireless interfaces, according to some embodiments.

The response protocols system 126 can be configured to determine the specific response protocol workflow associated with any event, whether emergency or not. In some embodiments, the response protocols system 126 works in conjunction with the identification system 118 to determine the correct response. In some embodiments, the response protocols system 126 works in conjunction with the real time location system 116 to determine the appropriate exit routes, evacuation points, shelter in place locations, etc. in some embodiments. In some embodiments, the response protocols system 126 works with the communication system 122 to deliver the specific event response workflow to user devices 124 via the output interface 114. The response protocols are specifically designed workflows that guide users through an event. In some embodiments, response protocols system 126 can execute in conjunction with the workflow system 136 to provide event specific workflows to users. For example, the protocol may contain symptoms in the case of a medical emergency and steps to be taken by the user to help the person having a medical emergency. In various implementation, the specific response protocol workflow may be specific to a sub-area of the area. For example, individuals in a building may receive a specific event response workflow based on the specific sub-area they are located in. In this example, during a fire emergency at an office building, John Doe may receive a specific event response workflow indicating John should break the window to get out of the building in the room (e.g., a sub-area) John is in and subsequently check-in after the specific event response workflow is completed, whereas Jane Doe may receive a specific event response workflow indicating Jane should proceed out the door of the room (e.g., a sub-area) and turn to the left and proceed to the exit directly in front of Jane and subsequently check-in after the specific event response workflow is completed. In another example, during a active shooter at a sporting event, John Doe may receive a specific event response workflow indicating John should take cover and lock the door of the suite (e.g., a sub-area) John is in and if able, take a picture of the sub-area, whereas Jane Doe may receive a specific event response workflow indicating Jane should proceed to the aisle of the row she is in and proceed down to the field and utilize the emergency exit in the north endzone and subsequently check-in after the specific event response workflow is completed.

The central processing system 102 can include security services source code 132. The security services source code 132 may be stored in memory 110 (or in database 138), which may be accessed by and/or run on processor 108. The security services data (e.g., institution data, user data, IoT data, etc.) may be stored on the same and/or different processor readable memory, which may be accessible by processor 108 when running the security services source code 132.

The interface system 134 can be configured to select content for display to users within resources (e.g., webpages, applications, etc.) and to provide content (e.g., graphical user interface (GUI)) to the user devices 124 and/or other systems described herein over the network 128 for display within the resources. The content from which the interface system 134 selects content may be provided by the central processing system 102 and/or database 138 via the network 128 to one or more user devices 124. In some implementations, the interface system 134 may select content to be displayed on the user devices 124. In such implementations, the interface system 134 may determine content to be generated and published in one or more content interfaces of resources (e.g., webpages, applications, etc.).

The workflow system 136 can be configured to generate customized workflows based on various factors including roles, events, facility/institutional status, and so on. In various implementations, the workflow system 136 may be part of the response protocol system 126. In various implementations, workflows can be customized by role such that every individual (e.g., during an event) can get a different workflow depending on their role. In some implementations, workflows can be customized by tenant such that every tenant can have different workflows for every role, to meet their needs. In some implementations, workflows can be contingent, and change based on the status of an area/facility. For example, when a facility is in normal mode (e.g., a status) visitors check in and get a badge, or parents check in and pick up a student before end of the day, etc. In this example however, when a facility is in after-hours mode (e.g., a different status), visitors are not allowed and parents can volunteer, etc., which can be especially highlighted in an emergency event. In various implementations, workflows described herein can be living workflows that relate to moving, organizing and leading actual human beings. Thus, improving efficient of individuals interacting with physical world as opposed to streamlining an administrative process.

Security system 100 can be used to provide security services in various security scenarios, such as gunfire, drills, medical emergencies, fire, natural disasters, etc. For example, in a gunfire scenario, the real time location system 116 and identification system 118 are configured to use the data from the IoT devices 104 (e.g., IR sensor, IP microphone, cameras, microphone, magnetometer, air quality sensor, camera, decibel sensor, wavelength estimator, etc.) to identify and locate gunfire and shooters during active shooter incident, according to some embodiments. Referring to security system 100 generally and with reference to the gunfire scenario example above, the real time location system 116 can configured to locate the shooter, the identification system 118 can be configured to identify the shooter, the real time location system 116 can be configured to determine a magnetic disturbance using the data received from the IoT devices 104, and the identification system 118 can be configured to determine whether the magnetic disturbance is associated with a gun. In the above example, once the security system 100 senses gun fire, the identification system 118 identifies the magnetic signature, barrel heat signature, deteriorating air quality, or other disturbance associated with the gun and tracks the gun by its magnetic disturbance, heat and other chemical signature throughout the building, according to some embodiments. Further in the above example, once the gunfire incident is detected, the central processing system 102 sends signals to the IoT devices 104 via the input interface 112. The signals can instruct the cameras of the IoT devices 104 to be activated to take photos and/or videos, according to some embodiments. The communication system 122 can be configured to generate reports including the recorded photos and/or videos and provide the reports to the alert system 106 and the user device 124 in real-time, according to some embodiments. The identification system 118 can also be configured to search within a database for any known people involved in the gunfire and/or on the scene, according to some embodiments. Continuing the above example, in some embodiments, if the shooter is identified as known to the security system 100, the communication system 122 provides profiles of the known person to the alert system 106 and the user devices 124. The communication system 122 may provide the photos or videos of the suspicious people to the alert system 106 and/or any other system connected to the network 128, according to some embodiments. The alert system 106 may use facial recognition technologies to identify the shooter from the suspicious people and if the shooter is carrying a mobile phone, the security system 100 may use various IoT Devices (e.g., BLE beacon sensors) to detect locations of the shooter in real time, according to some embodiments. Continuing the above example, the security system 100 may track the shooter with the shooter's mobile device (e.g., phone, watch, any other device connected to the internet), magnetic signature of the weapons, heat of the weapons, chemical signatures, etc., according to some embodiments. In any mass person event, including an active shooter, the security system 100 may manage the network 128 to relieve bandwidth constraints, for example, by turning off network cameras that are not in the vicinity of the incident, disabling video streaming, etc. Accordingly, security system 100 management of the network 128 can allow more efficient use of resources (e.g., memory 110, processor 108), which saves power and processing requirements, reduces bandwidth usage, and conserve data network usage.

The security system 100 can be used in a drill scenario (e.g., fire drill, lockdown drill, evacuate drill, tornado drill, etc.), according to some embodiments. During the drill, the security system 100 can locate all people and monitor traffic flows along with important time data within an area (e.g., a specific room, a building, etc.), according to some embodiments. The security system 100 can generate a report for any specific individual drill indicating an efficiency of the drill and can create summary reports for any specific kind of drill (e.g., lock-down, active shooter, fire, tornado, etc.), or a composite of all drills. These reports can be used for Federal, State, other regulatory, insurance or other legal requirements. The reports can be used for training and evaluation purposes to improve the efficacy of real situation response. In one example, utilizing time effectively during an active shooter scenario is essential to ensure the safety and well-being of any individual in the area. That is, in this example, reports can be generated to provide how long the police department took to arrive during a drill, or how fast a specific response protocol workflow was executed, enabling individual to train and evaluate how improvement can be executed to real situation response.

In another example, the security system 100 can be used in a medical emergency scenario. During the medical emergency the security system 100 can use IoT devices 104, external data sources 130, and user devices 124 to obtain a photograph of the injured person. In some embodiments, the photograph can be used for facial recognition identification. In some embodiments, the identification system 118 may use facial recognition, BLE beacon, UWB or another identification method to ensure the identity of the person. In some embodiments, the communication system 122 may share person specific medical or psychological information about the injured person to any authorized personnel. The real time location system 116 can provide the location of the incident, in some embodiments. In some embodiments, the security system 100 will store all data and meta-data associated with the medical emergency for future use (e.g., insurance, litigation, Federal, State or regulatory reporting, etc.).

Still referring to FIG. 1, system 100 can also be configured to provide integrated attendance services within an area (e.g., a school, a building, a park, a sporting event, a music event, an enclosed area, any area, etc.), according to some illustrative embodiments. System 100 can further include biometric data (e.g., fingerprints, face, etc.) 150, and other emergency systems (e.g., 911 emergency responders, police, fire-department, paramedics, school alert systems, etc.) 146, according to some embodiments. The memory 110 can further include an attendance system 140, a reconciliation engine 142, and a reunification system 152, according to some embodiments.

In some embodiments, the biometric data 150 is collected by the input interface 112 or a user devices 124 that is in communication with the input interface 112 via the network 128. The input interface 112 is comprised of multiple networked devices (e.g., iPad, tablet, camera of any wavelength, or other mobile device). The biometric data 150 may be collected by cameras, fingerprint scanners, retinal scanners, or other devices contained within the input interface 112 or the user devices 124. The biometric data 150 is person specific and may comprise of a picture of a person's face, a fingerprint, a retinal scan, or some other personal identification attribute. The identification of the user devices 124 and/or the biometric data 150 collected by the input interface 112 or the user devices 124 is communicated to the central processing system 102 through input interface 112 according to some embodiments. The network 128 allows the system 100 to know the location of each input interface 112. The user devices 104 and/or biometric data 150 provide person specific information to the central processing system 102 through the input interface 112 for recording the integrated attendance of a person at a location (e.g., classroom, bus, sports event, etc.) and at a specific time via the network 128, according to some embodiments. The identification of the user is determined by the biometric data 150, external data sources 130, and/or identification of the user devices 124 which is associated with particular users. The user devices 124 may include an application that reports the identification when in the presence of the mobile interface 112. In some embodiments, the application may not cause the identification to be reported if a password or other verification procedure is not performed on the user devices 124.

In some implementations, biometric data 150 can be used for human identification and authentication for physical and logical access. Biometric data 150 can be associated with a plurality of biometric data. Biometric data 150 is a digital reference of an individual's (e.g., customer, user) distinct characteristics obtained by processing one or more biometric samples from the individual. Biometric data may include, for example, biological (fingerprint, iris/retina, hand geometry, facial geometry, DNA, etc.) and behavioral (e.g., gait, gesture, keystroke dynamics, speech pattern, foot movement pattern, etc.) characteristics that reliably distinguish one individual from another. Digital representations of these characteristics can be stored in an electronic medium (e.g., database 138), and later used to authenticate the identity (e.g., biometrically match) of an individual. For example, an individual may upload a picture of themselves and during any subsequent authentication and/or validation a computing device (e.g., central processing system 102) may validate the picture. In this example, the computing device could validate (e.g., determine a biometric match) the picture via a camera on the user device (e.g., user devices 124) comparing the camera picture with the uploaded picture of the individual. In some implementations, to preserve privacy, the biometric data 150 associated with an individual may be cryptographically generated, encrypted, or otherwise obfuscated by any circuit of system 100.

In various implementations, a biometric match can utilize a biometric processing algorithm or a biometric matching algorithm (e.g., stored in database 138). The biometric processing algorithm or a biometric matching algorithm could be based on artificial intelligence or a machine-learning model. For example, a first machine-learning model may be trained to identify particular biometric samples (e.g., fingerprint, face, hand) and output a prediction. In this example, a second machine-learning model may be trained to identify to particular individual based on the identified particular biometric sample. In other examples, a machine-learning model may be trained to identify the biometric sample and the individual associated with the biometric sample. In various implementations, authenticating the biometric sample may include utilizing a machine learning algorithm (e.g., a neural network, convolutional neural network, recurrent neural network, linear regression model, and sparse vector machine). The central processing system 102 can input one or more biometric samples into the machine learning model, and receive an output from the model indicating if there is a biometric match.

Expanding generally on the biometric matching algorithm, the central processing system 102 may utilize various sensors and/or algorithms to execute the biometric matching algorithm for biometric data. For example, the central processing system 102 may utilize a Minutiae based fingerprint recognition algorithm and an optical scanner and/or capacitive scanner to determine a fingerprint match. In another example, the central processing system 102 may utilize a model, wavelet, Gabor filter, and/or hamming distance algorithm and an iris recognition camera to determine an iris match. In yet another example, the central processing system 102 may utilize principal component analysis using eigenfaces, linear discriminant analysis, elastic bunch graph matching, the hidden Markov model, the multilinear subspace learning, and/or the neuronal motivated dynamic link matching algorithm and a facial recognition camera to determine a face match. In yet another example, the central processing system 102 may utilize acoustic modeling (e.g., digital signal processing) and a microphone to determine a voice match.

The input interface 112 devices are connected via the network 128. Network connections are not limited to any specific type of network connection (e.g., Wi-Fi, LTE, 4G, 5G, etc.). The input interface 112 devices can be mobile and can operate on multiple different networks. The provided network flexibility and device mobility allow the system to function anywhere (e.g., with and/or without a network connection). The central processing system 102 can locate each input interface 112 by using a combination of location metrics (e.g., IP address on a local network, GPS location, triangulation, etc.). The central processing system 102 can use a combination of different types of data within a network to locate individuals for integrated attendance, according to some embodiments. In this way, the system 100 can provide integrated attendance services with higher precision, higher location accuracies, in a more flexible form (e.g., mobile) while utilizing existing computing devices, and siloed information (e.g., separate databases of different institutions), according to some embodiments.

For example, the input interface 112 can be mounted at the entrance of a classroom so that students can register their attendance with a user devices 124 or biometric data 150 collected by the input interface 112, in some embodiments. In some embodiments, in an emergency situation a teacher or school leader can disconnect the input interface 112 and take it with them to an evacuation point, allowing students to conduct integrated attendance when away from their traditional facility. In some embodiments, in an emergency situation, a teacher or school leader can use the input interface 112 as a communication link and command center to send and receive information to other constituencies (e.g., other school leaders, first responders, district officials, parents, etc.). In some embodiments, a teacher can take the input interface 112 and allow students to use integrated attendance to make sure everyone is gathered after a field trip. In some embodiments, a coach can use the input interface 112 to register the attendance of athletes traveling to a sporting event. In any embodiment, it does not matter if the input interface 112 has a stationary network 128 connection. The network 128 connection is flexible based on the location of the input interface 112 and network 128.

The attendance system 140 is configured to know which individuals should be in a particular area at a specific time (e.g., class roll, bus roster, field trip list, sports team, construction site, meeting room, self-quarantine, home, etc.), according to some embodiments. The attendance system 140 can include an embedded system clock that can timestamp the arrival of a student (e.g., 1:52.34 PM CST on Tuesday Jan. 4, 2020). The attendance module communicates integrated attendance to external data sources 130, in some embodiments. In some embodiments, the attendance systems communicates student attendance to emergency systems 120. In some embodiments, the attendance system 140 communicates information directly to another user device (e.g., user devices 124). For example, a principal may receive notifications of truancy, a parent may be notified that a student was present on the bus but not at their first class, or a teacher may receive a notification that a student has used integrated attendance for an excused absence (e.g., a sporting event, school council meeting, etc.). In another example, a construction site manager may receive notifications of when power tools are checked-in and checked-out (e.g., via an application). In another example, a doctor office manager may receive notifications when a patient test positive for coronavirus, and any subsequent movements of that individual (e.g., home, grocery store, doctor's office, etc.). In various implementations, the attendance system 140 can be integrated into the real time location system 116.

Referring to the attendance system 140 generally, the real time location system for tracking individuals and/or objects can be utilized by institutions (e.g., schools, construction sites, hospitals) to address regulatory requirement by entities (e.g., local government, state government, federal government, laws, UL standards, etc.) such that individuals and objects can be measured. Accordingly, the attendance system 140 can quantify where people have been (e.g., location) or currently are and what period of time each person was in one or more locations. For example, some states in the US require schools to measure the number of students attending such that tax dollars can be allocated to each school based on the number of students attending (e.g., each student gets $10,000). In this example, a regulatory requirement can be fulfilled utilizing the attendance system 140.

The reconciliation engine 142 can be configured to find missing persons (e.g., students, memory care patients, children, etc.). In some embodiments, the reconciliation engine 142 may be used to notify individuals (e.g., teachers or staff) of missing students. For example, the reconciliation engine 142 may be used when a school leader records the integrated attendance of an extra student (e.g., a student they are not responsible for). The reconciliation engine 142 is configured for students to use their own user devices 124 to provide integrated attendance and self-report their location, in some embodiments.

Referring to the reunification system 152 generally, integrated attendance can be used to reunify individuals (e.g., students) with authorized persons. The integrated attendance can bind/connect individuals to responsible parties in designated locations. This can allow security administrators to quickly identify who is with or in the custody of whom, and where they are located. For example, during an emergency, once all individuals are located, they can be reunified with authorized persons.

The reunification system 152 can be configured to match individuals with authorized persons to leave a designated area. In some implementations, systems described herein can execute various tasks and provide various data (e.g., from database 138) to the reunification system 152. For example, reunification system 152 may receive real time location information of an individual from the attendance system 140 (or real time location system 116) and identification information of the individual from the identification system 118. In this example, the attendance system may utilize various gathered information from database 138 and various systems described herein to locate individual, determine authorized individual for renunciation, authorize the authorized individuals (e.g., after receiving appropriate credentials, explained in detail with reference to Universal Credential Management System 148), and send notifications to authorized individuals that an individual was reunified with another the authorized individual.

The system 100 can be used to provide integrated attendance in various scenarios, such as sporting events, daily bus rides, field trips, construction equipment, contract tracing, in various non-classroom school locations, etc. For example, on a daily bus ride, the attendance system 140 is configured to account for and locate all students, according to some embodiments. In some embodiments, once students exit the bus and enter the classroom the attendance system 140 and reconciliation engine 142 work together to ensure that all students who were on the bus are now in the classroom. In another example, students who have recorded integrated attendance throughout the school day can record integrated attendance for the bus to the sporting event (e.g., between multiple scenarios), in some embodiments. In this example, the attendance system 140 and reconciliation engine 142 work together to notify teachers, principals, or other staff members via the staff member's mobile device (e.g., user devices 124) of an excused absence and the location of the student.

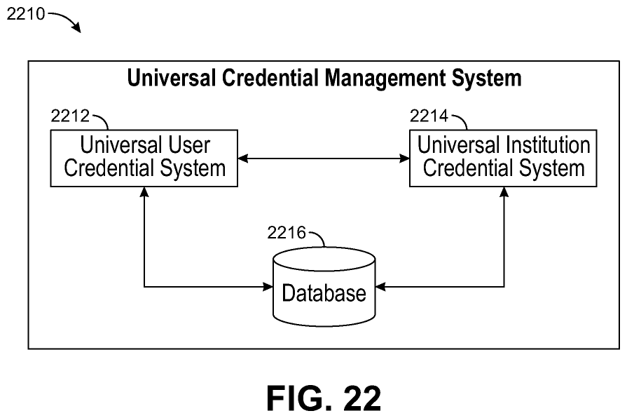

Still referring to FIG. 1, the system 100 can also include at least one data processing system or processing circuit, such as a universal credential management system 148. The universal credential management system 148 can communicate via the network 128, for example with user devices 124, IoT devices 104, external data sources 128, any other system described herein. In addition to the processing circuit, the universal credential management system 148 may include one or more databases (e.g., 138) configured to store data. The universal credential management system 148 may also include one or more credential systems (e.g., universal user credential system 112, and universal institution credential system 114) configured to receive data via the network 128 and to provide data from the universal credential management system 148 to any of the other systems and devices on the network 128. The universal credential management system 148 may be any form of computing device that includes a processing circuit and a memory. Additional details relating to the functions of the universal credential management system 148 are provided herein with respect to FIG. 22.

The user devices 124 can be configured to exchange information with other systems and devices of FIG. 1 via the network 128. The user devices 124 may be any form of computing device that includes a processing circuit and a memory. The user devices 124 can execute a software application (e.g., a web browser or other application) to retrieve content from other systems and devices over network 128. Such an application may be configured to store, manage, and/or administer user credentials, certificates, and/or other user information from the universal credential management system 148. In one implementation, the user devices 124 may execute a web browser application which provides the one or more user credentials such that a user can utilize one or more credentials at particular institutions.

For example, the user devices 124 can be configured to exchange information over the network 128 using protocols in accordance with the Open Systems Interconnection (OSI) layers, e.g., using an OSI layer-4 transport protocol such as the User Datagram Protocol (UDP), the Transmission Control Protocol (TCP), or the Stream Control Transmission Protocol (SCTP), layered over an OSI layer-3 network protocol such as Internet Protocol (IP), e.g., IPv4 or IPv6. In some implementations, the user devices 124 includes one or more hardware elements for facilitating data input and data presentation, e.g., a keyboard, a display, a touch screen, a microphone, a speaker, and/or a haptic feedback device. In some implementations, the user devices 124 includes buttons, e.g., function-specific buttons (e.g., audio device volume controls such as volume up, volume down, mute, etc.) and/or function agnostic buttons (e.g., a soft button that can be assigned specific functionality at a software level).

In some implementations, the user devices 124 runs an operating system managing execution of software applications on the user devices 124. In various implementations, the operating system is provided with the user devices 124. In some implementations, the user devices 124 executes a browser application (e.g., a web browser) capable of receiving data formatted according to the suite of hypertext application protocols such as the Hypertext Transfer Protocol (HTTP) and/or HTTP encrypted by Transport Layer Security (HTTPS). In various implementations, the browser facilitates interaction with one or more systems and devices via interfaces presented at the user devices 124 in the form of one or more web pages. In some implementations, the browser application is provided to the user devices 124. In various implementations, the user devices 124 executes a custom application, e.g., a game or other application that interacts with systems and devices, e.g., the universal credential management system 148.

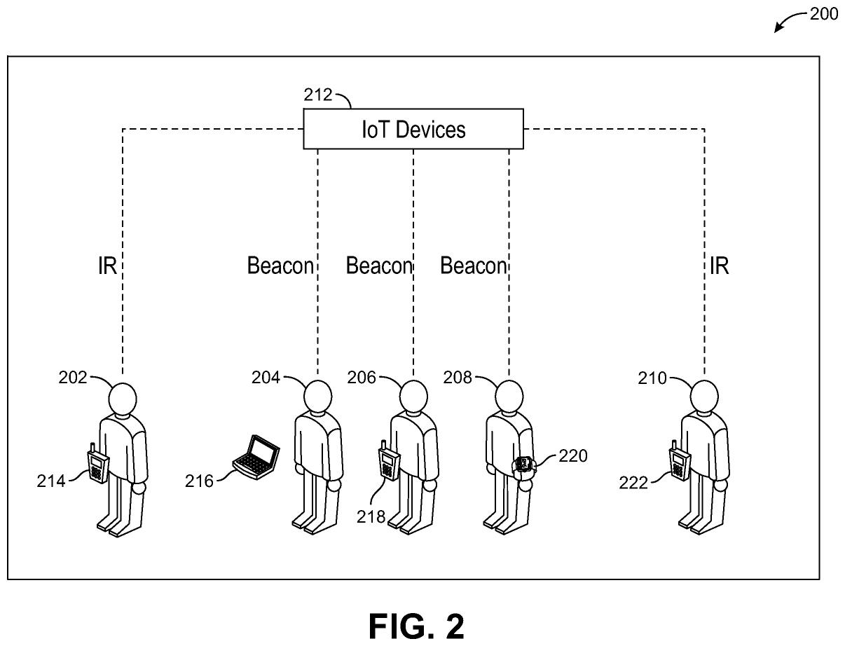

Referring now to FIG. 2, a diagram illustrating a security system 200 providing real time location and identification of people within a room, according to some example embodiments. The security system 200 includes similar features and functionality as the security system 100 of FIG. 1, according to some embodiments. The security system 200 includes IoT Devices 212 and one or more user devices (e.g., 214, 216, 218, 220, 222). In some embodiments, the security system 200 will also include the expected identity of people in the room, similarly, as described in the identification system 118 of FIG. 1. The IoT Devices 212 are installed throughout the room, according to some embodiments. The IoT Devices 212 can include one or more IR sensors, one or more cameras, and/or one or more BLE/UWB sensors, and any other IoT Devices (e.g., described in FIG. 1.), according to some embodiments, for purpose of the diagram only BLE/UWB operate similarly. The security system 200 may determine a total number of people (e.g., five people) within the room using counts from, for example, the one or more IR sensors and/or beacon sensors. The security system 200 may also determine occupancy density of each room, sub-area, and/or area. The security system 200 may determines a total number of people within the room using images and/or video from the one or more cameras (e.g., cameras), according to some embodiments. In various implementations, the security system 200 may determine a first number of people who carry beacons (e.g., people 204, 206, and 208 carry beacons) with them within the room. In some implementations, the security system 200 may further determine a second number of people who carry phones (e.g., people 202 and 210 carry phones) with them within the room. In this way, the security system 200 determines a total number of people within the room by adding the first number of people and the second number of people, according to some embodiments. The security system 200 may be configured to compare the total number determined from different IoT devices 212 to determine an accurate count of total people within the room, according to some embodiments. The security system 200 may compare the accurate count of total people with an expected count of people to determine whether there is any person missing or whether there is any stranger being in the room according to some embodiments. In some cases, people may carry multiple identifying pieces (e.g., user device and BLE beacon), in this case the security system 200 may deploy statistical inference algorithms to count and identify the correct people in the room or facility, explained in detail with reference to FIG. 1.

The security system 200 may also be configured to identify each individual person within the room using the IoT Devices 212. For example, the security system 200 may identify each person using photos from the one or more cameras and search for a personal file associated with the person within a database (e.g., database 138, external data sources 130 in FIG. 1.), according to some embodiments. If the security system 200 identifies that one or more people within the room are not within the database, the security system 200 may generate an alert report to report the suspicious people to administrators, according to some embodiments.

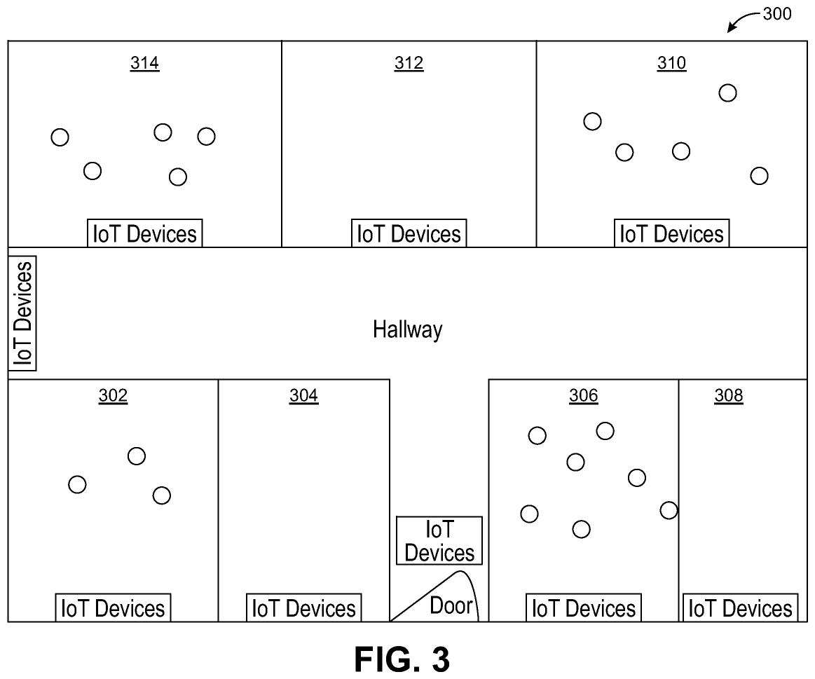

Referring now to FIG. 3, a diagram illustrating a security system 300 providing real time location and identification of people within a building, according to some example embodiments. The building includes one or more individual rooms (e.g., hallway, door, rooms 302, 304, 306, 308, 310, 312, and 314) and one or more IoT devices, according to some embodiments. In various implementations, the security system 300 includes multiple sub-systems such that each sub-system may be installed in a single room or hallway. Each sub-system includes similar features and functionality as the security system 200 of FIG. 2, and security system 100 of FIG. 1, according to some embodiments. All the sub-systems are connected to a network (e.g., network 128) so that the security system 300 can access each individual sub-system and aggregate data to locate and identify all the activities and people within the building and/or area, according to some embodiments.

For example, in the room 302, the sub-system determines a total number of people (e.g., three people) and identifies each individual people (e.g., associates a name with each person). In that example, the sub-system provides the total number and identifications to the security system 300 such that the security system 300 can aggregate the counts from each sub-system to determine a total count within the building (e.g., a bottom-up analysis, 20 people). In another implementations, the security system 300 may monitor all entry and egress locations to identify and calculate the total number of people that enter and exit the building (e.g. a top-down analysis). The system 300 may compare the top-down and bottom-up analysis to identify or reconcile discrepancies of identified and counted people in the building, in some embodiments. The security system 300 also determines a total number of unknown people determined by the identifications of each sub-system, according to some embodiments. The security system 300 can further locate the unknown people within the building and track and record their activities within the building, according to some embodiments. The security system 300 can also report these unknown people to the security administrators, and/or any other system described herein, according to some embodiments.

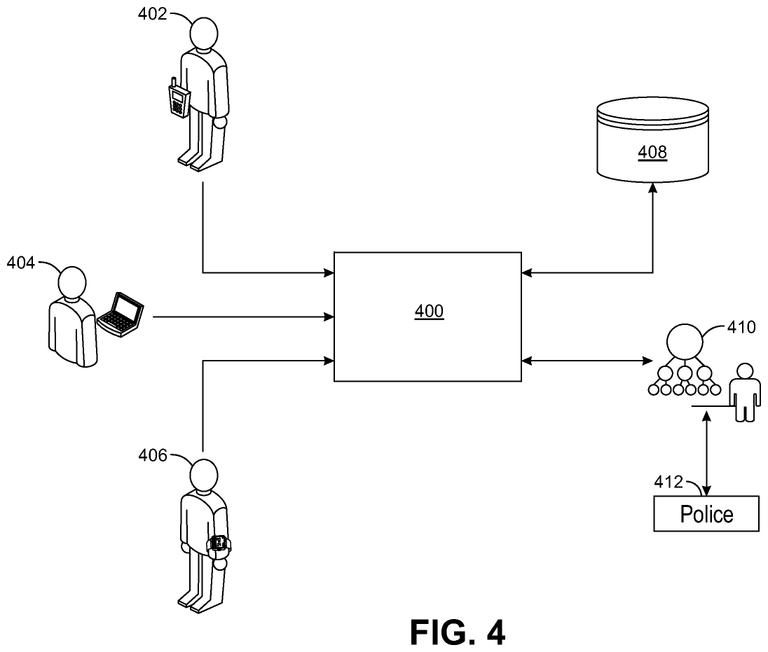

Referring now to FIG. 4, a diagram illustrating operations of a security system 400 in a tip-line scenario, according to some example embodiments. The security system 400 is used to provide security services within a community (e.g., school, hospital, construction site, office building, etc.), according to some embodiments. The security system 400 includes similar features and functionality as the security system 100 of FIG. 1, according to some embodiments. The security system 400 receives tip data from one or more community members (e.g., community members 402, 404, and 406) and/or top data from a database 408 (e.g., a student information system (SIS) database, employee records, hospital records, similar to external data sources 130 in FIG. 1, etc.), according to some embodiments. The tip data indicates suspicious activities and people according to some embodiments. The tip data may include text comments/concerns from community members (e.g., students, parents, teachers, doctors, administrators, community members, etc.), according to some embodiments. The tip data may include social media screen shots, photo taken in a crowd, etc. The security system 400 can utilize uses the tip data to determine suspicious events and people and generate report to alert the administrator 410, according to some embodiments. The administrator can in turn alert and communicate with the police 412 or other organizations, according to some embodiments. The report may include profile of the suspicious people, according to some embodiments. For example, in a school setting, a report based on tip data may include student profile, grade trend, attendance trend, life changing information, medical history, etc., according to some embodiments. In some embodiments, the security system 400 may use all information gathered from community members and any databases 408 (e.g., similar features and functionality external data sources 130 and/or database 138 in FIG. 1) to construct threat matrices or prioritize responses of a plurality of responses. In some embodiments, the security system 400 may use a communication system (e.g., communication system 122 in FIG. 1) to directly share consistent information with Police, other law enforcement, or relevant authorities.

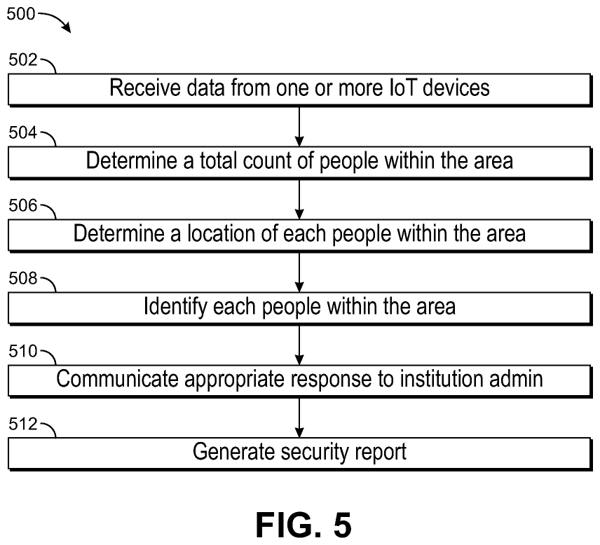

Referring now to FIG. 5, a flow diagram illustrating a process 500 of providing security services within an area, according to some example embodiments. The process 500 can be operated using the security system 100 of FIG. 1, as described above according to some embodiments. At operation 502, receiving a plurality of monitored data from one or more IoT devices located within the area and associated with an institution. The IoT devices include communication system of IoT devices 104 and user devices 124 of FIG. 1, according to some embodiments.

At operation 504, determining a total count of people within the area. The total count of people can be determined using monitored data from various IoT devices 104 and performing various computational processes executed by the central processing system 102, according to some embodiments. The total count of people can be verified using data from different IoT devices 104, according to some embodiments.

At operation 506, determining a location of each people within the area. The location of each people within the area can be determined using data from the IoT devices 104, external data sources 130, and/or user devices 124, according to some embodiments. A location of an event can be also determined using data from the IoT devices 104, external data sources 130, smart situation modeler 144, and/or user device 124, according to some embodiments.

At operation 508, identifying each person and event within the area. Each person within the area can be identified by determining whether the people is in a database or expected in the area, according to some embodiments. Identification of an event can also be determined using data from the IoT devices 104, external data sources 130, and/or user device 124, according to some embodiments. In one example, smart situation modeler 144 may utilize a facial recognition algorithm to identify each person and event within the area.

At operation 510, communicating appropriate response to correct people. The communication system 122 communicates the appropriate response protocol from the response protocol system 126 to the specified recipients, explained in detail with reference to FIG. 1.

At operation 512, generating report. In various implementations, reports can indicate locations and identifications of individuals and events is generated and provided to administrations and/or emergency personnel, according to some embodiments. The report may also include alert information of suspicious people or activity within the area according to some embodiments. For example, the smart situation modeler 144 can generate output predictions (e.g., threat matrix, potential threat score, severity of situation estimator).

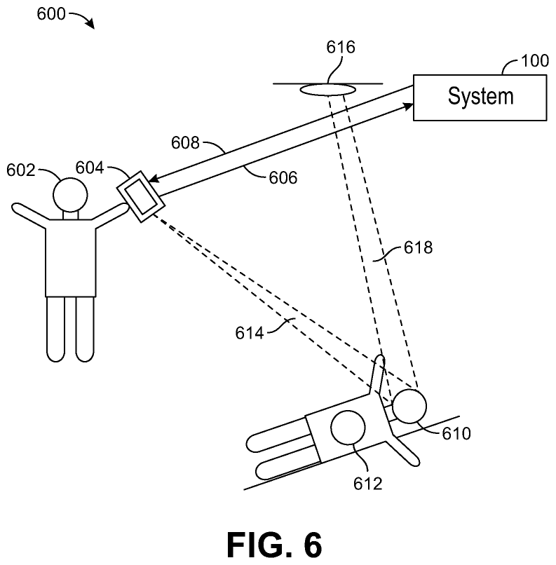

Referring now to FIG. 6, a flow diagram illustrating the operation of security system 600 in the situation where an unknown student 610 is injured, according to some embodiments. A staff member 602 is present and in possession of a smart device 604. The staff member 602 uses the smart device 604 to take a photo of the unknown student 610. The photo 606 is then uploaded to security system 100, as described in detail with reference to FIG. 1. Security system 100 identifies the unknown student 610 using facial recognition from the photo 606 or the data from the BLE/UWB Beacon Tag 612. The security system 100 then sends an individual health plan 608 to the smart device 604. The individual health plan 608 is based on personalized care instructions or important person specific information. The staff member 602 is then able to use the individual health plan to help the unknown student 610. A camera 616 present in the room also takes a photo 618 of the unknown student 610. The camera 616 communicates the photo to the security system 100. The security system 100 identifies the unknown student 610 using the photo 618 and the beacon tag 612. The system can then generate a report that is broadcast by the system to individuals (e.g., via network 128).

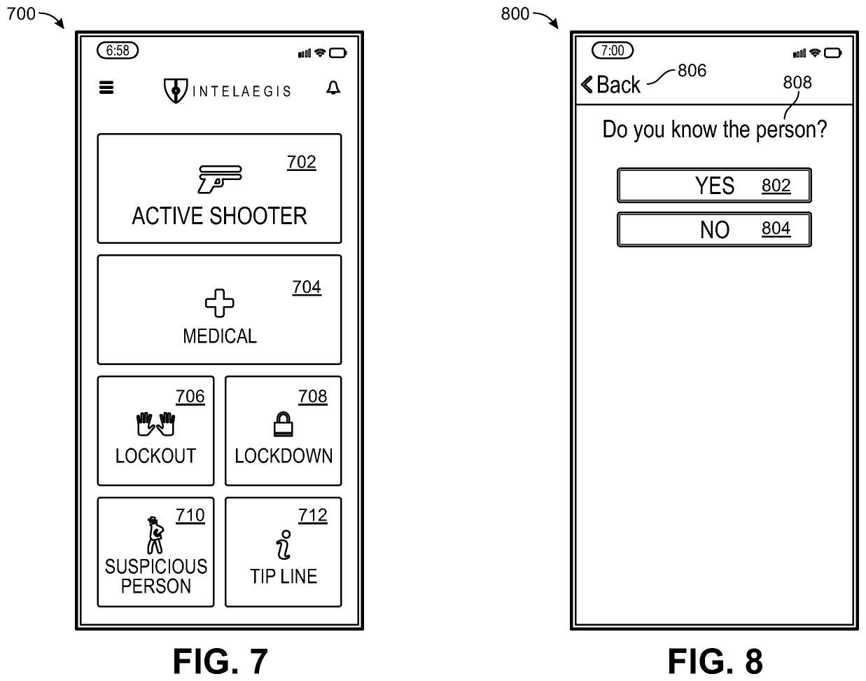

Referring now to FIG. 7, an illustration of the user interface of a mobile device application menu screen 700, according to some embodiments. The menu screen 700 allows users to send information (via the network 128) to the security system 100, as detailed in FIG. 1, about situations (e.g., potentially dangerous). The user interface has several sub-interfaces including, but not limited to, the active shooter interface 702, the medical interface 704, the lockout interface 706, the lockdown interface 708, the suspicious person interface 710, and the tip line interface 712. Each sub-interface can be associated with a particular event and once clicked by a user, can provide an event contingent workflow similar to the workflows explained in the workflow system 136 and response protocols system 126 of FIG. 1. For example, during an active shooter event an individual should select the active shooter interface 702, during a medical emergency event an individual should select the medical interface 704, during a lockout event an individual should select the lockout interface 706, during a lockdown event an individual should select the lockdown interface 708, during a suspicious person event (e.g., individual notices a suspicious person) an individual should select the suspicious person interface 710, and during a tip line event (e.g., individual would like to provide a tip) an individual should select the tip line interface 712, and so on. Accordingly, the user interface can provide immediate (real-time) communication to the system 100 over a network (e.g., network 128).

Referring now to FIG. 8, an illustration of the user interface in the first step 800 of the medical interface 704 customized workflow, according to some embodiments. The user is prompted with the question “Do you know this person?” 808. The user then has the choice to select yes 802 or no 804 to answer the question 808. The user also has the option to go back to select back 806 to return to the menu screen 700.

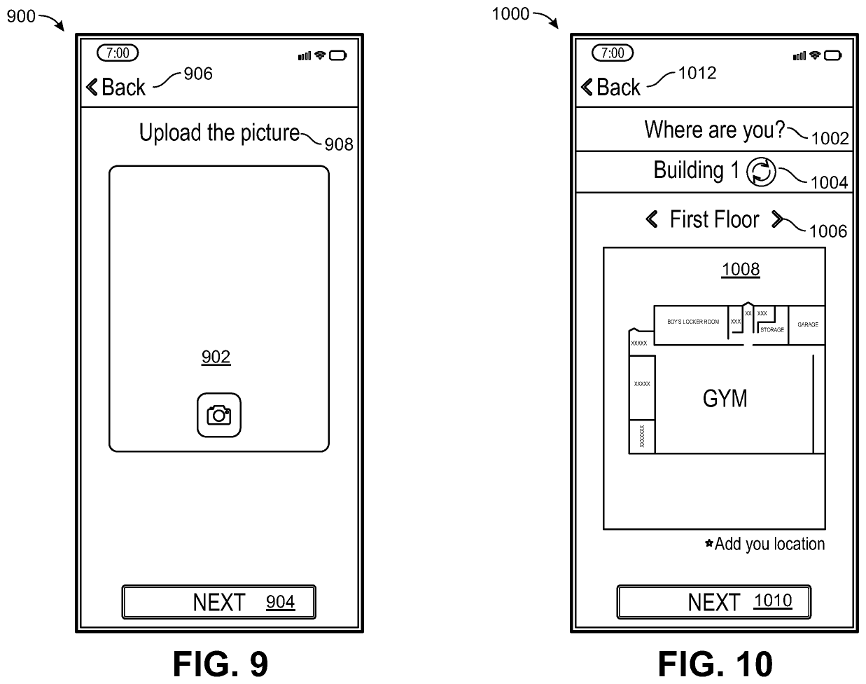

Referring now to FIG. 9, an illustration of the user interface in the second step 900 of a medical interface 704 customized workflow, the picture upload screen 900, according to some embodiments. The user is prompted to upload a picture 908 of the unknown person to be sent to the system. The user can select the camera button 902 to either take a photo or upload a photo from the user's device (e.g., photo library stored on the user's mobile device). The user can select next 904 after the user has taken or selected a photo. The user also has the option of going back to the previous screen by selecting back 906. The system uses the picture to perform facial recognition and identify the person having a medical emergency.

Referring now to FIG. 10, an illustration of the user interface in the third step 1000 of a medical interface 704 customized workflow, the location screen, according to some embodiments. The user can be prompted to provide the user's location 1002. The user is able to select the building 1004 (or area) and the floor 1006 (if applicable). The user is then able to scroll through a map 1008 to select the user's location. After the user has selected the location, the user can select next 1010 to proceed to the next step and have the location information uploaded to the system. The user can also select back 1012 to go to the previous step.

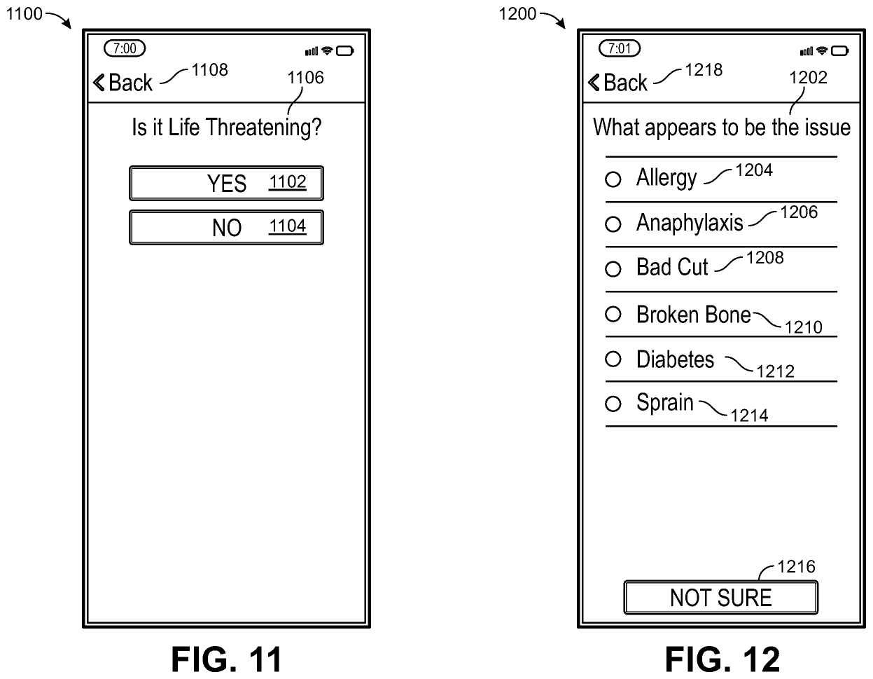

Referring now to FIG. 11, an illustration of the user interface in the fourth step 1100 of a medical interface 704 customized workflow, according to some embodiments. The user is prompted with the question “Is it Life Threatening?” 1106. The user can then select yes 1102, or no 1104, to answer the question 1106. The user may also have the option to go back to the previous step by selecting back 1108. This question may be important as people such as nurses, principles, and student resource officers receive the information in real time. If the user selects that the medical emergency is life threatening, the information can be sent directly to first responders (e.g., an automated call to 911 or other emergency network). In various implementations, the information may be routed via the network 128 to first responders in real time without any individual calling or communicating with the first responders. In some implementations, information may be aggregated from a plurality of individuals such that the first responders may receive information from more than one individual (e.g., to prevent false positive emergencies, to prevent false negatives emergencies, etc.) such that first responders can make a determination if the emergency is real, and not a hoax or the result of an individual incorrectly entering information.

Referring now to FIG. 12, an illustration of the user interface in the fifth step 1200 of a medical interface 704 customized workflow, according to some embodiments. The user is prompted with the question “What appears to be the issue?” 1202. The user can select allergy 1204, anaphylaxis 1206, bad cut 1208, broken bone 1210, diabetes 1212, and sprain 1214. The user also has the option to select not sure 1216 if the user does not know what the medical issue is. The user can also select back to go to the previous step. This information is important as it alerts the responders of the type of medical emergency that is taking place, which allows the responders to properly prepare for the medical emergency. In various implementations, the information may be packaged with the information from the fourth step 1100 to be sent to first responders. In some implementations, this information may be sent separately from the information from the fourth step 1100 to the first responders.

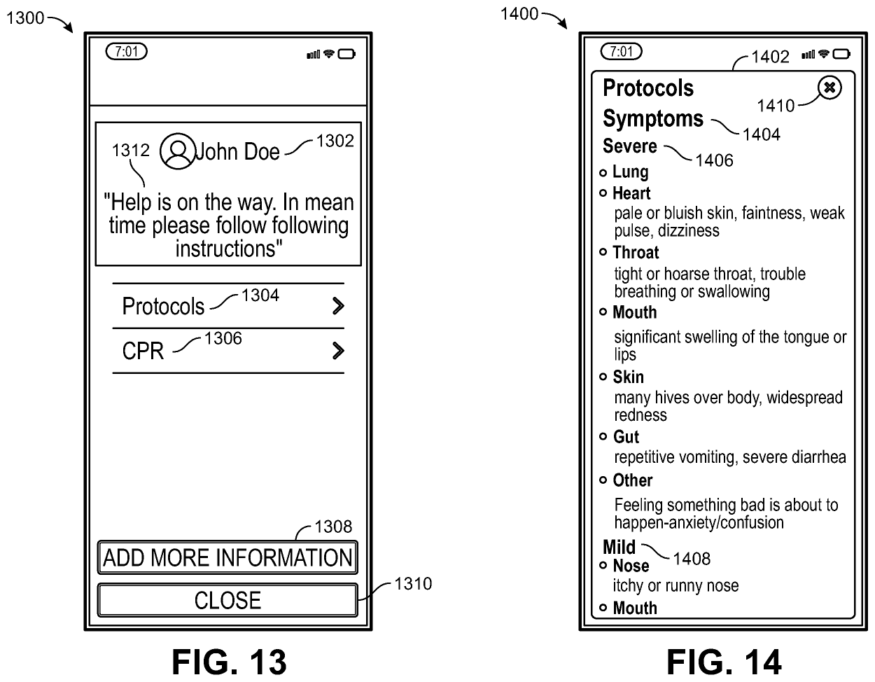

Referring now to FIG. 13, an illustration of the user interface after the information has been entered into the medical interface 704, sixth step 1300. In various implementations, the medical interface 704 can provide the user with information as to the identity of the unknown person 1302 and provides the user with a message 1312, such as help is on the way. The user is also prompted with options to see protocols 1304 for the helping the person having a medical emergency and to see how to perform CPR 1306. The user also has the option to add more information 1308 and to close the screen 1310 and return to the previous screen.

Referring now to FIG. 14, an illustration of the user interface protocol screen 1400. The protocol screen 1400 is reached after the user selects protocols during a medical disaster 1400, according to some embodiments. The protocol 1402 may be specific to the injured person or a general protocol based on the persons reported issue. The protocol may contain symptoms 1404. The symptoms may be broken down into different severities, such as severe 1406 and mild 1408. The information regarding the symptoms and severity of the medical condition can be used to help the user determine the severity of the medical emergency. The user has the option of returning to the previous screen by selecting the close button 1410.

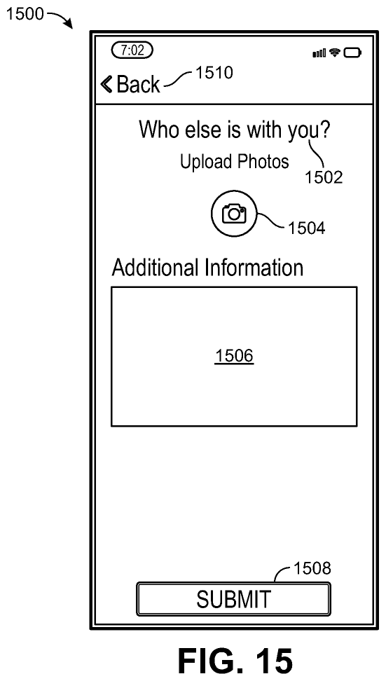

Referring now to FIG. 15, an illustration of the user interface in the add more information screen 1500, according to some embodiments. The user is prompted with the question “Who else is with you” 1502. The user is able to upload additional photos by selecting the camera button 1504 or provide additional information in the textbox 1506. Each of these options can provide the system with the identification of other people present. Once the photo or additional information has been added, the user can select submit 1508 to send the information to the system. The user can also return to the previous view by selecting back 1510.

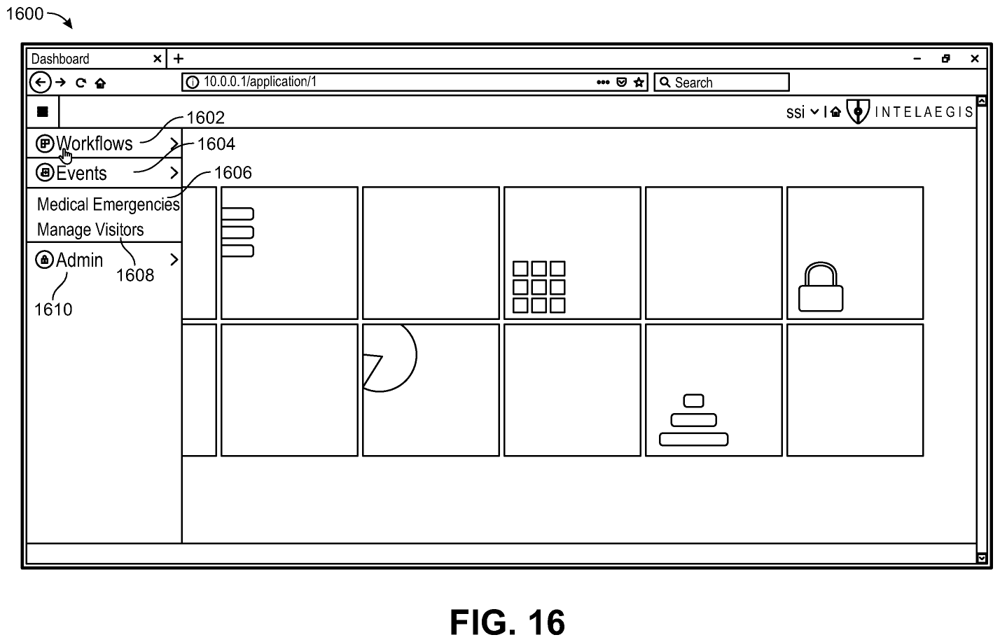

Referring now to FIG. 16, an illustration of the web dashboard home screen 1600, according to some embodiments. The dashboard allows system administrators, first responders, or other people with access to see the information uploaded by users during an incident. The user of the dashboard has the option to select items in the categories of workflow 1602, events 1604 and admin 1610. Under events 1604 the user may select medical emergencies 1606 or manage visitors 1608. In various implementations, the web dashboard home screen 1600 can be customized based on the areas utilized by the security system 100. In some implementations, the web dashboard home screen 1600 can access various systems and storages in system 100, via the network 128.

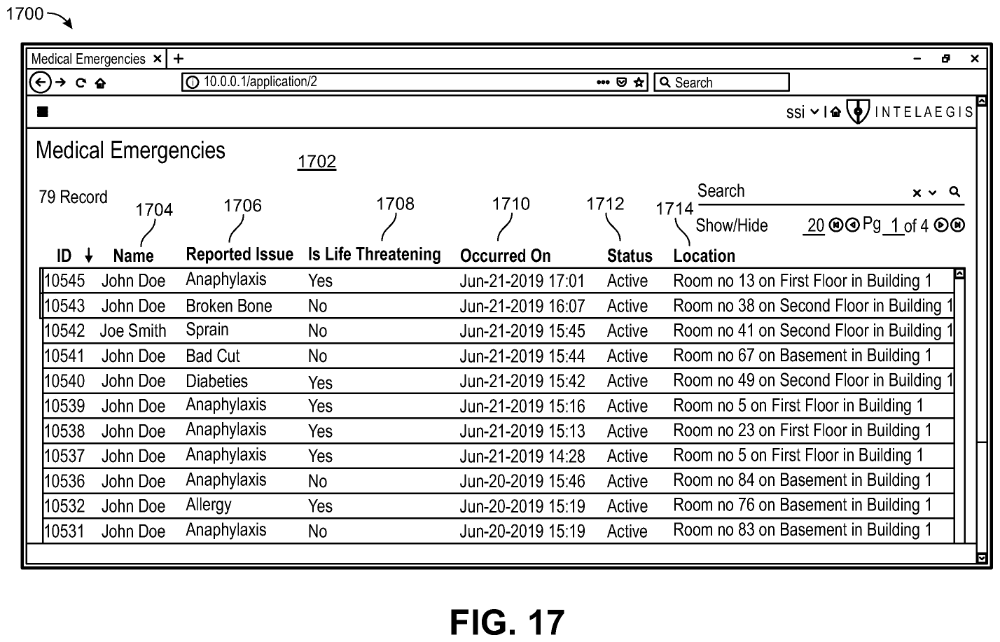

Referring now to FIG. 17, an illustration of the web dashboard medical emergencies screen 1700, according to some embodiments. The user can see all of the medical emergencies 1702 that the system has received. The user can see columns for the name of the person with the medical emergency 1704, the reported issue 1706, whether the medical emergency is life threatening 1708, when the medical emergency occurred 1710, the status of the medical emergency 1712, and the location of the medical emergency 1714.

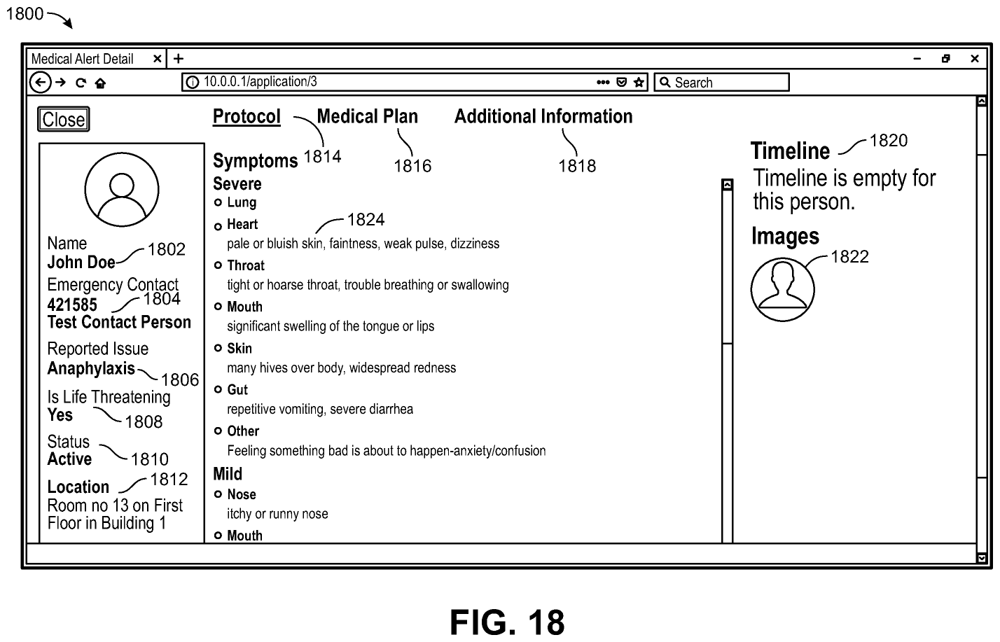

Referring now to FIG. 18, an illustration of the web dashboard 1800 depicting the incident report screen, according to some embodiments. The user can see the name of the person 1802, the person's emergency contact 1804, the reported issue 1806, whether the medical emergency is life threatening 1808, the status of the medical emergency 1810, the location of person 1812, the timeline of the events 1820, and any pictures that have been uploaded to the system 1822. The user can also select to see the protocol 1814, the medical plan 1816, and any additional information 1818 uploaded to the system. In the illustration the current protocol 1824 is shown.

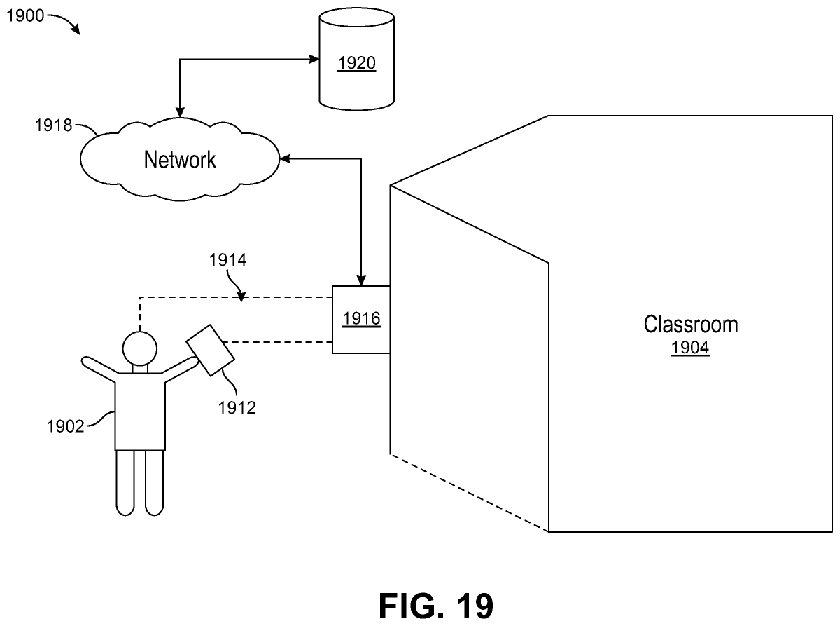

Referring now to FIG. 19, a diagram illustrating an integrated attendance system 1900 providing integrated attendance for a student 1902 entering a classroom 1904 according to some example embodiments. The security system 1900 is configured similarly as the system 100 of FIG. 1 according to some embodiments. The integrated attendance system 1900 includes user devices 1912 (similar features and functionality as user devices 124 in FIG. 1), biometric data 1914, a mobile input interface device 1916 (similar features and functionality as input interface 112 in FIG. 1), a network 1918 (similar features and functionality as network 128 in FIG. 1), and a database (held on either a cloud, edge, or local server, similar features and functionality as network 128 in FIG. 1) 1920. In various implementations, integrated attendance system 1900 includes similar features and functionality of FIG. 1.

The security system 1900 may be configured to record the integrated attendance of each individual student 1902 within the classroom 1904 using the student's user device 1912, student's biometric data 1914, or mobile input interface device 1916. For example, the security system 1900 may use the mobile input interface device 1916 to read a student's unique QR code that is displayed on the student's user device 1912 in some embodiments. In some embodiments, the student's user device 1912 may communicate integrated attendance for a student 1902 to the mobile input interface device 1916 via NFC, Bluetooth, Wi-Fi Direct, or other close range communication protocol. The student's user device 1912 may also be configured to send location information to the system 1900 via a network 1918 when the student is present at a particular location. In some embodiments, the system 1900 may record the student's integrated attendance using photos from the one or more cameras embedded in the mobile input interface device 1916 and identifying the student 1902 via facial recognition, retinal scanning, or other identification information stored in a personal file associated with the student 1902 within database 1920, according to some embodiments. In some embodiments, a student 1902 can record integrated attendance by scanning the students fingerprint at a mobile input interface device 1916. The student 1902 is identified using information stored in a personal file (e.g., in database 1920) associated with the student 1902 and integrated attendance is recorded by the system 1900.

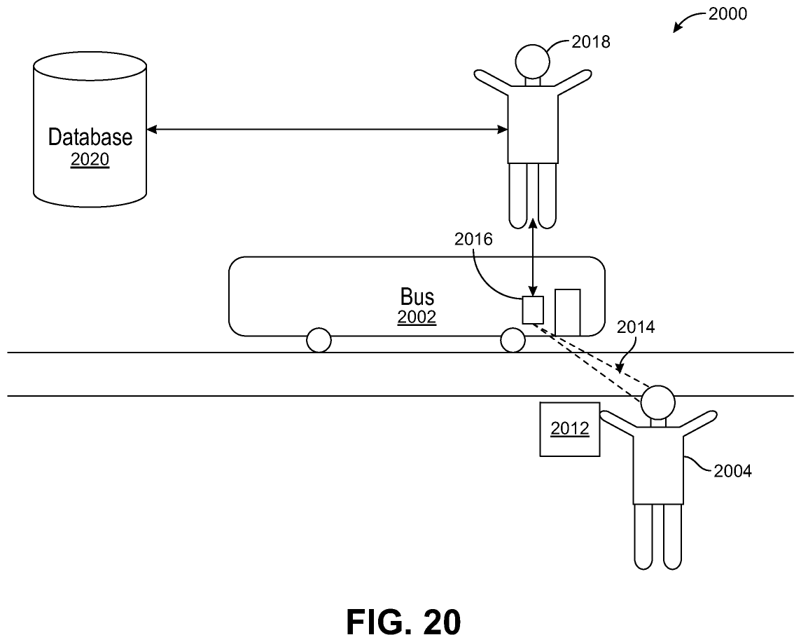

Referring now to FIG. 20, a diagram illustrating a security system 2000 providing integrated attendance on a bus 2002 according to some example embodiments. The security system 2000 includes a student's user device 2012, student's biometric data 2014, mobile input interface device 2016, and telecom network 2018 (e.g., LTE, 4G, 5G, etc.), and a database (held on either a cloud, edge, or local server) 2020, according to some embodiments. In various implementations, security system 2000 includes similar features and functionality of FIG. 1.

For example, on the bus 2002, a student 2004 is able to use their user device 2012 and/or biometric data 2014 in conjunction with the mobile input interface device 2016 to report integrated attendance on the bus 2002, in some embodiments. The mobile input interface device 2016 includes similar features and functionality of the mobile input interface device 1916 and input interface 112. The mobile input interface device 2016 can communicate the integrated attendance data via the telecom network 2018 to the security system 2000. The security system 2000 can also update the database 2020 when the student 2004 has exited the bus 2002 and reached the student's drop off location (e.g., school, home, sporting event, off-site evacuation point, etc.).

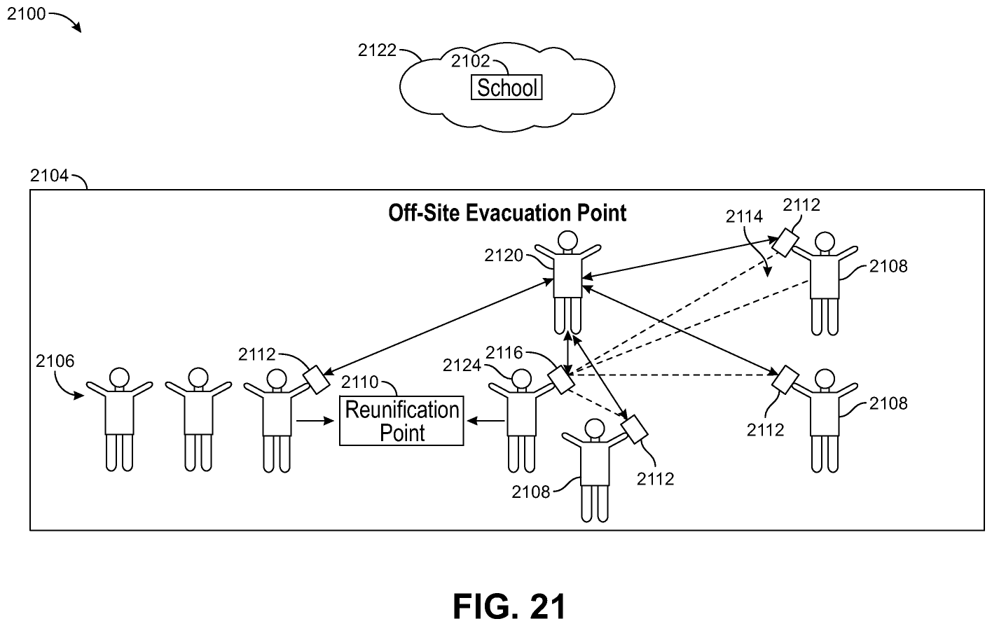

Referring now to FIG. 21, a diagram illustrating integrated attendance system 2100 in a remote location, according to some example embodiments. The integrated attendance system 2100 is comprised of user devices 2112, mobile input interface 2116, biometric data 2114, and rendezvous point network 2120 (e.g., Wi-Fi, LTE, 4G, 5G, etc.). In some embodiments, a school leader 2124 can take the mobile input device 2116 from their classroom and transport it to a location away from school grounds 2102, such as an off-site evacuation point 2104. The mobile input device 2116 can be used to register integrated attendance from a student's user device 2112 and/or biometric data 2114, regardless of the location. The mobile input device 2116 can also be a communication link and command center to link an individual school leader with other affected people, in some embodiments. The network 2120 is not the same network as the school network 2122. In some embodiments the mobile input interface 2116 can operate on any network. In some embodiments, the reconciliation engine 142, attendance system 140, and reunification system 152 from system 100 are used in system 2100 for locating students in an evacuation. In some embodiments, the mobile input device 2116 is used to reunify students 2108 and parents 2106. In this example, the mobile input device 2116 can be used to match students and parents with biometric data 2114 or unique QR codes generated by user devices 2112 and read by mobile input interface 2116. In this configuration, the system 2100 can ensure parents 2106 are matched with the correct students 2108, in some embodiments. In some embodiments, the system 2100 can notify parents via their mobile devices 2112 regarding the location of their student 2108 and inform the parents 2106 as to the off-site evacuation point 2104 and a reunification point 2110 where parents 2106 are reunified with their students 2108. In various implementations, integrated attendance system 2100 includes similar features and functionality of FIG. 1.

Referring now to FIG. 22, a block diagram depicting an implementation 2210 of a universal credential management system 148 is shown, according to an illustrative implementation. The universal credential management system 148 can be run or otherwise be executed on one or more processors of a computing device, such as those described below in FIG. 28. In broad overview, the credential management system 148 can include a universal user credential system 2212, a universal institution credential system 2214, and a database 2216. In some implementations, the universal user credential system 2212 can be rendered at the user devices 124 such that a user (e.g., person) can configure and/or receive user credential associated with a particular institution (e.g., school, hospital, airport, or business). In various implementation, user credentials are associated with roles, where each role requires certain permissions that give a user access.

For example, assume Person 1 is a user identified as a parent at a school. Person 1 will receive digital visitor credentials that will not unlock doors, or provide any access to tenant data, but it could (depending on tenant policies) allow the parent (i.e., user) to activate emergency protocols at the tenant's facilities. Furthermore, Person 1 is also an employee at a bank. Person 1 could use the same digital credential as at the school above (i.e. the same QR code, face, etc.) but it will contain different permissions that are associated with Person 1's role at the bank. Person 1's employee bank credentials will allow Person 1 to unlock doors, have access to defined bank data in an application, and use the full application that could be deployed by the bank. This is one person (i.e., Person 1), one identifier (e.g. face, QR code, driver's license, etc), one computing device, but different credentials depending on the tenant Person 1 is visiting. Every user will have many credentials that are different at each affiliated tenant. In some implementations, one person could have a plurality of identifiers and operate the application on a plurality of computing devices. In various implementations, personal credentials (e.g., background checks, etc.) can be different than contractor credentials (e.g., certificates of insurance, etc.). That is, in some implementations, if a person is in the role of contractor both the personal and contractor credentials may have to be satisfied to gain entry.

Referring generally to the implementation 2210, each user can have a different role at each institution. The implementation 2210 can provide customized workflows (e.g., from workflow system 136) to that user depending on their role (e.g., person could also have multiple roles like guardian and contractor and will get different workflow depending on role), and status of institution (e.g., normal, emergency, active shooter, after hours, etc.) based on events and system 100. Accordingly, given the implementation 2210, there can be an infinite number of combinations since roles, workflows, and facility/institutional status can each be customized (e.g., by the tenant or dependent on the current environment). In various implementations, users can have credentials that can span across unaffiliated entities (sometimes referred to as a “multi-tenancy structure”) such that credentials go with people (as they move locations) enabling systems and individuals to recreate physical traffic patterns (e.g., coronavirus contact tracing). In some implementations, individual users can see their data across different institutions, but institutions may be restricted to only seeing user data associated with the institution.

In some implementations, the universal user credential system 2212 can be utilized by a user to manage user certificates and any other user information. For example, a certificate could include a background check, CPR certification, machinery certification, etc. In some implementations, the universal user credential system 2212 can be utilized by a user to manage user consents. For example, the user could add biometric information utilizing a computing device (e.g., user devices 124). In another example, the user could designate certain information to be shared with the tenant (e.g., peanut allergy information, asthma information, etc.)

In some implementations, the universal institution credential system 2214 can be rendered at the user devices 124 such that each tenant (e.g., system administrator) can configure and administer user credentials, determine tenant policies, configure permissions, and/or designate roles. That is, each tenant (i.e. schools, office buildings, hospitals, etc.) can set up credentials for an individual related to that institution utilizing the universal institution credential system 2214. When the individual visits another unrelated tenant, that other institution is able to set up its own permissions for the individual. The universal credential management system 148 associates each tenant's credentials, certificates, and/or other user information together such that an individual can see their own credentials, certificates, and/or other user information at the two different locations. For example, a person who is a parent at School X and a client at Bank Y will see their School X parent credentials and their Bank Y credentials in the same place (i.e., universal credential management system 148) and those credentials will be different. In some embodiments, the credentials can be used with facial recognition, QR codes from mobile phone or badges, or other means to grant full or temporary building access (e.g., Bluetooth Low Energy (BLE) beacon), require background checks for entry, provide entry to building amenities (i.e. health clubs, etc.), and any other permissions that any tenant would like to impose. At the same time, an individual could also add their own credentials (i.e., user consents) utilizing the universal user credential system 2212. For example, User 2 could perform a background check on themselves, so that all tenants would then know they have been background checked. In other implementations, a user could add licenses or other personal information they would want to share through their credentials.

The universal credential management system 148 can include at least one database 2216 (e.g., similar features and functionality to database 138). In various implementations, database 2216 may be integrated into database 138. The database 2216 can include data structures for storing information such as the information associated with the universal user credential system 2212, and/or the universal institution credential system 2214, and/or other additional information. The database 2216 can be part of the universal credential management system 148, or a separate component that the universal credential management system 148, universal user credential system 2212, or universal institution credential system 2214 can access via the network 128. The database 2216 can also be distributed throughout system 100. For example, the database 2216 can include multiple databases associated with the user devices 124, universal credential management system 148, or both. In one implementation, the universal credential management system 148 includes the database 2216.

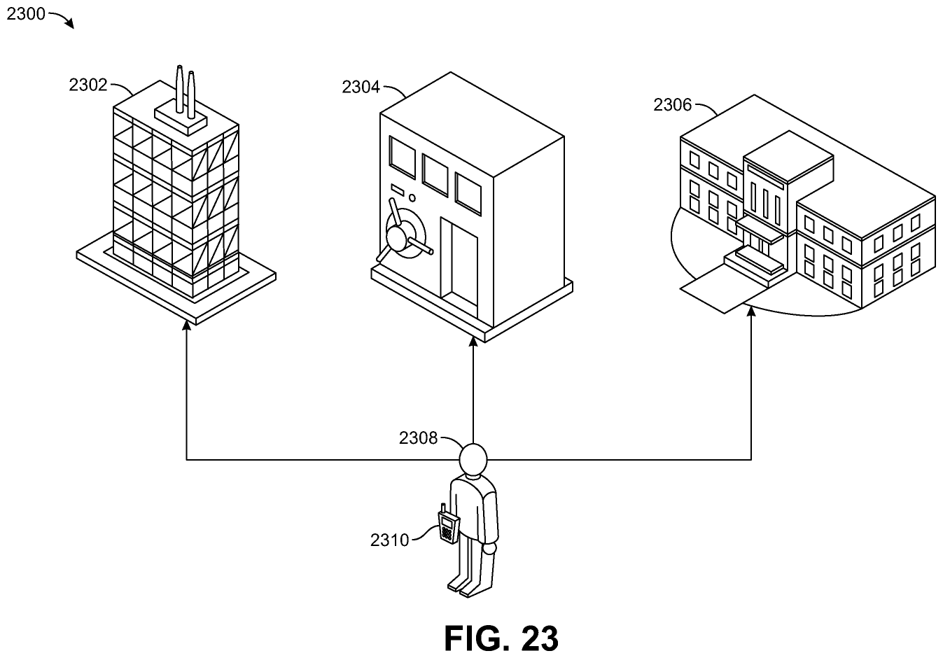

Referring now to FIG. 23, a schematic drawing of an example configuration of the universal credential management system 148 within a multi-tenancy structure, according to an illustrative implementation. As shown, the example implementation includes a first institution 2302, a second institution 2304, a third institution 2306, a user 2308, and a user device 3210. In some implementations, each institution and user can communicate over network 128, as described in detail with reference to FIG. 1.

In one example, the configuration could be company W (e.g., 2302), bank X (e.g., 2304), school Y (e.g., 2306), and Person Z (e.g., 2308), where Person Z is associated with each of the institutions. Each institution in the configuration could have a separate and distinct roles for Person Z. In this example, Person Z could be an employee of Company W where Person Z can access Company W's building during a set period of time, and receive access to certain areas of the building (e.g., if Person Z is a system administrator, Person Z could have access to the data closet). Further in this example, Person Z could be a client of Bank X where Person Z has access to Bank X's ATM 24/7 and has access to Bank X's building during normal business hours. Moreover, in this example, Person Z could be a parent with a child at School Y where the parent can have access to their child when their child is at School Y or Person Z could have access to a parking lot for picking up their child after school Y is let out for the day.

In other examples, the configuration could be different such that a different person has different roles and credentials for accessing different institutions. However, in each configuration, the system 100 can allow a user 2308 to have credentials (e.g., on user device 2310) at an infinite number of tenants while being maintained and managed in one central location (i.e., universal credential management system 148). Thus, improving the user experience of each user while providing tenants the ability to set roles, manage certificates, manage user information, manage policies, and manage permissions associated with user credential of each tenant's institution. In yet another example, the configuration could allow health official to contract trace an individual testing positive for a disease as the individual travels to one or more institutions.

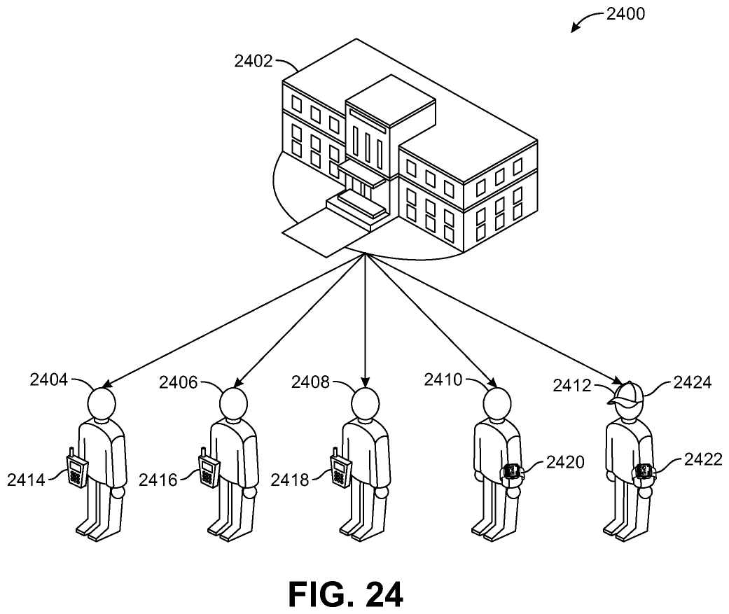

Referring now to FIG. 24, a schematic drawing of an example configuration of the universal credential management system 148 within a multi-tenancy structure, according to an illustrative implementation. As shown, the example implementation includes an institution 2402, and a plurality of users (e.g., 2404, 2406, 2408, 2410, and 2412) and user devices (e.g., 2414, 2416, 1418, 2420, 2422, and 2424). In some implementations, each user and institution can communicate over network 128, as described in detail with reference to FIG. 1.

In one example, the configuration could be associated with a school and the plurality of users that interact with the school. The school could have a plurality of roles based on the tenant policies and permissions. That is, in this example, there could be a superintendent, a principal, teachers, students, and parents where each categorization is associated with a particular role. In some implementations, a role could be customized based on a specific user. For example, one teacher could be CPR certified and thus, have access to the certain medical equipment throughout the school.

In other examples, the configuration could be different such that a different institution unaffiliated with the above example and could have different roles, different workflows, and require different credentials for that institution. However, in each configuration, the universal credential management system 148 can allow each institution to manage their roles and credential in a centralized location such that the user of the institutions can also manage their user access in a centralize location and have an single authorization code (e.g., stored on a user device and/or devices) associated with all the institutions that grants access to certain areas and/or buildings based on the role associated with each institution.

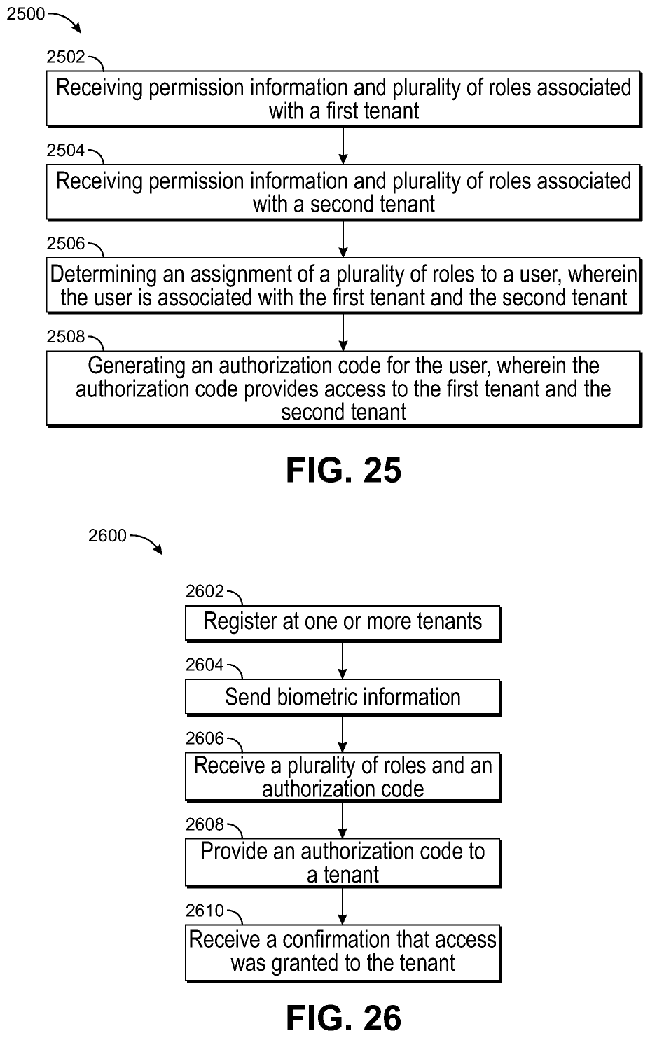

Referring now to FIG. 25, a flow diagram illustrating a process 2500 of providing management of user credentials within a multi-tenancy structure, according to an illustrative implementation. The process 2500 can be operated using system 100 of FIG. 1, as described in detail above according to some embodiments. At operation 2502, the one or more processing circuits can receive permission information and a plurality of roles associated with a first institution. That is, permission information could be associated with a plurality of users where each user has a specific role associated with the first institution. For example, the institution could be School A and the permission information could be associated with door access, and computer access, whereas the specific roles could include superintendent, principal, teachers, students, and parents.

At operation 2504, the one or more processing circuits can receive permission information and a plurality of roles associated with a second institution. That is, the second institution is unaffiliated with first institution and has it own distinct and separate permission information and roles.

At operation 2506, the one or more processing circuits can determine an assignment of a plurality of roles to a user, wherein the user is associated with the first institution and the second institution. That is, the user can have distinct and separate roles associated with each institution. For example, the user may be a teacher at a school and may be a janitor at a hospital.

At operation 2508, the one or more processing circuits can generate an authorization code for the user, wherein the authorization code provides access to the first institution and the second institution. That is, the user can access certain areas and/or buildings associated with each institution based on the assigned role associated with the institution.

Referring now to FIG. 26, a flow diagram illustrating a process 2600 of a user gaining access to one or more institutions within a multi-tenancy structure, according to an illustrative implementation. The process 2600 can be operated using system 100 of FIG. 1, as described in detail above according to some embodiments. At operation 2602, at least one computing device operably coupled to at least one memory can be configured to register, by a user, at one or more institutions. That is, the user can register themselves at an infinite number of institutions. In some implementations, each institution can also register the user.

At operation 2604, at least one computing device operably coupled to at least one memory can be configured to send, by the user, biometric information. That is, the biometric information is submitted such that the user can facilitate access to area and/or buildings of institutions at a future time. For example, the user may submit a fingerprint, facial recognition information, and/or any other biometric information to each institution. In some implementations, the user can determine which institution can utilize which biometric information that was previously submitted. For example, the user may not want the school to have facial recognition information, whereas the user is okay with a bank having the facial recognition information.

At operation 2606, at least one computing device operably coupled to at least one memory can be configured to receive, via a universal credential management system, a plurality of roles and an authorization code. That is, the user can be assigned roles associated with the institutions the user is registered with. Further, the authorization code is a unique code associated with the particular user such that the user can utilize the authorization code to access areas and/or buildings associated with a plurality of institutions. In some implementations, the authorization code is a single code that can be utilized across institutions.

At operation 2608, at least one computing device operably coupled to at least one memory can be configured to provide, by the user, the authorization code to an institution. That is, the user is beginning a process of gaining access to an area and/or building associated with a particular institution. For example, the user may be a teacher and is trying to get into the school before normal business hours. In another example, the user may be a superintendent trying to get into their office. In some embodiments, the user may also have to provide enhanced security information (e.g., biometric information) for authorization purposes.

At operation 2610, at least one computing device operably coupled to at least one memory can be configured to receive, via the universal credential management system, a confirmation that access was granted to the institution. That is, the universal credential management system received the authorization code and confirmed the authorization code with and/or without enhanced security information such that the user gained access to the particular area and/or building the user desired to gain access to. In some implementations, the access may be denied and the user may not be able to access the particular area and/or building the user desired to gain access to. For example, a network administrator at a company should be able to access the network closest but a human resource employee should not be able to gain access to the network closest.

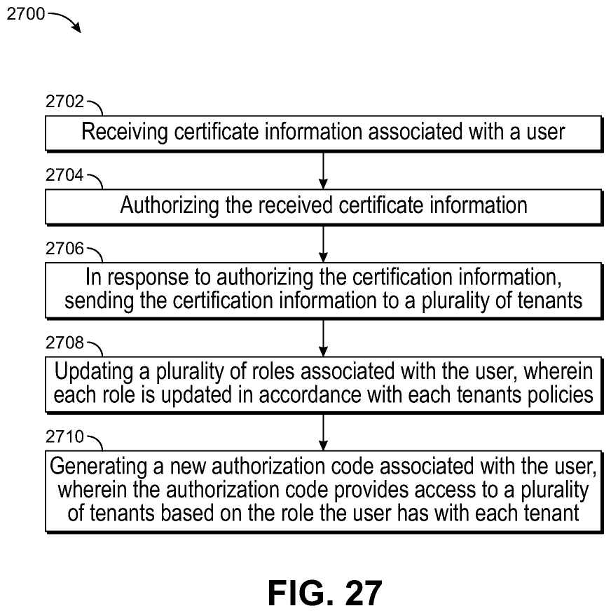

Referring now to FIG. 27, a flow diagram illustrating a process 2700 of a updating the authorization code based on information provided by the user within a multi-tenancy structure, according to an illustrative implementation. The process 2700 can be operated using system 100 of FIG. 1, as described in detail above according to some embodiments. At operation 2702, the at least one processor can receive, by a user computing device, certificate information associated with a user. That is, the certification information can be a plurality information associated with a specific certification. In some implementations, the certification information can be associated with a particular institution. In other implementations, the certification information can be associated with a plurality of institutions. For example, the certification information could be associated with background check completed by a 3^{rd} party, where each institution would desire to have that information. In another example, the certification information could be associated with a machinery operation certification, where only one institution would desire to have that information. In yet another example, the certification information could be associated with a CPR certification, where each institution would desire to have that information.

At operation 2704, the at least one processor can authorize the received certificate information, and at operation 2706, in response to authorizing the certification information, the at least one processor can send the certification information to a plurality of institutions. That is, the institutions that desire to obtain the certification information.

At operation 2708, the at least one processor can update a plurality of roles associated with the user, wherein each role is updated in accordance with each institutions policies. That is, the roles for each institution associated with the user can change based on the received certification information. For example, if an information technology (IT) intern passes the CompTIA A+ exam, the role of the IT intern could change such that they can now access the network closest. In another example, if a worker at a fast food chain passes an in-house test for being a cashier, the role of the worker could change such that they could now have access to the cash register. In yet another example, if a nurse passes an operation room procedure exam administered by the Hospital the nurse works at, the role of the nurse could change such that they could now have access to the operation rooms inside the hospital. However, if the IT intern also works at the fast food chain, the passing of the CompTIA A+ exam does not change the role the IT intern has at the fast food chain.

At operation 2710, the at least one process can generate a new authorization code associated with the user, wherein the new authorization code provides access to the plurality of institutions based on the role the user has with each institution. That is, the previous authorization code could have provided less access to an area and/or building of a institution since it required a certain certification to gain that access.

FIG. 28 illustrates a depiction of a computer system 2800 that can be used, for example, to implement a system 100, external data sources 130, user devices 124, IoT devices 104, emergency systems 146, and/or various other example systems described in the present disclosure. The computing system 2800 includes a bus 2805 or other communication component for communicating information and a processor 2810 coupled to the bus 2805 for processing information. The computing system 2800 also includes main memory 2815, such as a random-access memory (RAM) or other dynamic storage device, coupled to the bus 2805 for storing information, and instructions to be executed by the processor 2810. Main memory 2815 can also be used for storing position information, temporary variables, or other intermediate information during execution of instructions by the processor 2810. The computing system 2800 may further include a read only memory (ROM) 2820 or other static storage device coupled to the bus 2805 for storing static information and instructions for the processor 2810. A storage device 2825, such as a solid-state device, magnetic disk or optical disk, is coupled to the bus 2805 for persistently storing information and instructions.

The computing system 2800 may be coupled via the bus 2805 to a display 2835, such as a liquid crystal display, or active matrix display, for displaying information to a user. An input device 2830, such as a keyboard including alphanumeric and other keys, may be coupled to the bus 2805 for communicating information, and command selections to the processor 2810. In another arrangement, the input device 2830 has a touch screen display 2835. The input device 2830 can include any type of biometric sensor, a cursor control, such as a mouse, a trackball, or cursor direction keys, for communicating direction information and command selections to the processor 2810 and for controlling cursor movement on the display 2835.

In some arrangements, the computing system 2800 may include a communications adapter 2840, such as a networking adapter. Communications adapter 2840 may be coupled to bus 2805 and may be configured to enable communications with a computing or communications network 128 and/or other computing systems. In various illustrative arrangements, any type of networking configuration may be achieved using communications adapter 2840, such as wired (e.g., via Ethernet), wireless (e.g., via WiFi, Bluetooth, and so on), satellite (e.g., via GPS) pre-configured, ad-hoc, LAN, WAN, and so on.

According to various arrangements, the processes that effectuate illustrative arrangements that are described herein can be achieved by the computing system 2800 in response to the processor 2810 executing an arrangement of instructions contained in main memory 2815. Such instructions can be read into main memory 2815 from another computer-readable medium, such as the storage device 2825. Execution of the arrangement of instructions contained in main memory 2815 causes the computing system 2800 to perform the illustrative processes described herein. One or more processors in a multi-processing arrangement may also be employed to execute the instructions contained in main memory 2815. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 28, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The terms “data processing system” or “processor” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more subsystems, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, arrangements of the subject matter described in this specification can be carried out using a computer having a display device, e.g., a quantum dot display (QLED), organic light-emitting diode (OLED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile input, or other biometric information. In addition, a computer can interact with a user by sending documents to and receiving documents from a device that is used by the user; for example, by sending web pages to a web browser on a user's client device in response to requests received from the web browser.

Arrangements of the subject matter described in this specification can be carried out using a computing system that includes a back-end component, e.g., as a data server, or that includes a middleware component, e.g., an application server, or that includes a front-end component, e.g., a client computer having a graphical user interface or a web browser through which a user can interact with an arrangement of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some arrangements, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative arrangements, the features disclosed herein may be implemented on a smart television circuit (or connected television circuit, hybrid television circuit, and so on), which may include a processing circuit configured to integrate Internet connectivity with more traditional television programming sources (e.g., received via cable, satellite, over-the-air, or other signals). The smart television circuit may be physically incorporated into a television set or may include a separate device such as a set-top box, Blu-ray or other digital media player, game console, hotel television system, and other companion device. A smart television circuit may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television circuit may be configured to provide a home screen or top-level screen including icons for a plurality of different applications, such as a web browser and a plurality of streaming media services, a connected cable or satellite media source, other web “channels,” and so on. The smart television circuit may further be configured to provide an electronic programming guide to the user. A companion application to the smart television circuit may be operable on a mobile computing device to provide additional information about available programs to a user, to allow the user to control the smart television circuit, and so on. In alternate arrangements, the features may be implemented on a laptop computer or other personal computer, a smartphone, other mobile phone, handheld computer, a tablet PC, or other computing device.

While this specification contains many specific implementation details and/or arrangement details, these should not be construed as limitations on the scope of any inventions or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations and/or arrangements described above should not be understood as requiring such separation in all implementations and/or arrangements, and it should be understood that the described program components and systems can generally be integrated together in a single software product or packaged into multiple software products.

Having now described some illustrative implementations, implementations, illustrative arrangements, and arrangements it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed only in connection with one implementation and/or arrangement are not intended to be excluded from a similar role in other implementations or arrangements.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations and/or arrangements consisting of the items listed thereafter exclusively. In one arrangement, the systems and methods described herein consist of one, each combination of more than one, or all of the described elements, acts, or components.

Any references to implementations, arrangements, or elements or acts of the systems and methods herein referred to in the singular may also embrace implementations and/or arrangements including a plurality of these elements, and any references in plural to any implementation, arrangement, or element or act herein may also embrace implementations and/or arrangements including only a single element. References in the singular or plural form are not intended to limit the presently disclosed systems or methods, their components, acts, or elements to single or plural configurations. References to any act or element being based on any information, act or element may include implementations and/or arrangements where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

Any arrangement disclosed herein may be combined with any other arrangement, and references to “an arrangement,” “some arrangements,” “an alternate arrangement,” “various arrangements,” “one arrangement” or the like are not necessarily mutually exclusive and are intended to indicate that a particular feature, structure, or characteristic described in connection with the arrangement may be included in at least one arrangement. Such terms as used herein are not necessarily all referring to the same arrangement. Any arrangement may be combined with any other arrangement, inclusively or exclusively, in any manner consistent with the aspects and arrangements disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to controlling the display of content of information resources, the systems and methods described herein can include applied to other environments. The foregoing implementations and/or arrangements are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system for providing security services, comprising:
at least one computing device operably coupled to at least one memory configured to:
receive data from one or more IoT devices associated with an institution;
determine a total count of people within an area;
determine a location for each people within the area;
identify each people within the area; and
generate a security report.

2. The system of claim 1, wherein the at least one computing device operably coupled to the at least one memory is further configured to:
identify each people within the area based analyzing profiles from a database.

3. The system of claim 1, wherein the at least one computing device operably coupled to the at least one memory is further configured to:
register, by a user device, a first user at the institution;
send, by the user device, biometric information of the first user;
receive, via a universal credential management system, a plurality of roles and an authorization code;
provide, by the user device, the authorization code to the institution; and
receive, via the universal credential management system, a confirmation that access was granted to the institution.

4. The system of claim 1, wherein the security report includes the total count of people, the location of each people, and an identification of each people within the area.

5. The system of claim 1, wherein the at least one computing device operably coupled to the at least one memory is further configured to:
receive, by a user device, certification information associated with a second user;
authorize the received certification information; and
in response to authorizing the certification information, send the certification information to a plurality of institutions comprising at least the institution.

6. The system of claim 1, wherein the at least one computing device operably coupled to the at least one memory is further configured to:
determine whether there is suspicious people within the area using the total count of people and identification of each people.

7. The system of claim 1, wherein the at least one computing device operably coupled to the at least one memory is further configured to:
determine an event location of an event associated with the area.

8. The system of claim 1, wherein the at least one computing device operably coupled to the at least one memory is further configured to:
receive first permission information and a first plurality of roles associated with the institution;
receive second permission information and a second plurality of roles associated with a second institution;
determine an assignment of a customized plurality of roles to a user, wherein the user is associated with the institution and the second institution; and
generate an authorization code for the user, wherein the authorization code provides access to the institution and the second institution.

9. The system of claim 1, wherein the at least one computing device operably coupled to the at least one memory is further configured to:
receiving, via a user device, a user identity; and
determine a time for the user identity and storing the location, the time and the user identity.

10. A method of institution security based on a security model in a computer network environment, the method comprising:
receiving, by one or more processing circuits, data from one or more IoT devices associated with an institution;
determining, by the one or more processing circuits, a total count of people within an area;
determining, by the one or more processing circuits, a location for each people within the area;
identifying, by the one or more processing circuits, each people within the area; and
generating, by the one or more processing circuits, a security report.

11. The method of claim 10, further comprising,
identifying, by the one or more processing circuits, each people within the area based analyzing profiles from a database.

12. The method of claim 10, further comprising:
registering, by the one or more processing circuits, a first user at the institution;
sending, by the one or more processing circuits, biometric information of the first user;
receiving, by the one or more processing circuits via a universal credential management system, a plurality of roles and an authorization code;
providing, by the one or more processing circuits to a user device of the first user, the authorization code to the institution; and
receiving, by the one or more processing circuits via the universal credential management system, a confirmation that access was granted to the institution.

13. The method of claim 10, wherein the security report includes the total count of people, the location of each people, and an identification of each people within the area.

14. The method of claim 10, further comprising:
receiving, by the one or more processing circuits via a user device, certification information associated with a second user;
authorizing, by the one or more processing circuits, the received certification information; and
in response to authorizing the certification information, sending, by the one or more processing circuits, the certification information to a plurality of institutions comprising at least the institution.

15. The method of claim 10, further comprising:
determining, by the one or more processing circuits, whether there is suspicious people within the area using the total count of people and identification of each people.

16. The method of claim 10, further comprising:
determining, by the one or more processing circuits, an event location of an event associated with the area.

17. The method of claim 10, further comprising:
receiving, by the one or more processing circuits, first permission information and a first plurality of roles associated with the institution;
receiving, by the one or more processing circuits, second permission information and a second plurality of roles associated with a second institution;
determining, by the one or more processing circuits, an assignment of a customized plurality of roles to a user, wherein the user is associated with the institution and the second institution; and
generating, by the one or more processing circuits, an authorization code for the user, wherein the authorization code provides access to the institution and the second institution.

18. The method of claim 10, further comprising:
receiving, by the one or more processing circuits via a user device, a user identity; and
determining, by the one or more processing circuits, a time for the user identity and storing the location, the time and the user identity.

19. One or more computer-readable storage media having instructions stored thereon that, when executed by at least one processor, cause the at least one processor to perform operations comprising:
receiving data from one or more IoT devices associated with an institution;
determining a total count of people within an area;
determining a location for each people within the area;
identifying each people within the area; and
generating a security report.

20. The one or more computer-readable storage media of claim 19, the operations further comprising:
registering a first user at the institution;
sending biometric information of the first user;
receiving, via a universal credential management system, a plurality of roles and an authorization code;
providing, to a user device of the first user, the authorization code to the institution; and
receiving, via the universal credential management system, a confirmation that access was granted to the institution.
